(19) United States
(12) Patent Application Publication
(10) Pub. No.: US 2008/0113287 A1
(43) Pub. Date: May 15, 2008

(54) ELECTROPHOTOGRAPHIC IMAGE-RECEIVING SHEET AND PROCESS FOR IMAGE FORMATION USING THE SAME

(75) Inventors: Yoshisada NAKAMURA, Shizuoka (JP); Yoshio Tani, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd., Kanagawa (JP)

(21) Appl. No.: 11/964,634

(22) Filed: Dec. 26, 2007

Related U.S. Application Data
(62) Division of application No. 10/663,841, filed on Sep. 17, 2003, now abandoned.

(30) Foreign Application Priority Data
Sep. 18, 2002 (JP) 2002-272201
Sep. 27, 2002 (JP) 2002-283299

(51) Int. Cl. B32B 27/32; B32B 27/10

(52) U.S. Cl. 430/104; 428/523; 428/513; 427/407.1; 430/125.31

(57) ABSTRACT

To provide an image-receiving sheet for electrophotography that suppresses blocking, allows toner images to fix satisfactorily, has excellent glossiness and reduced brittleness and can form high-quality images and to provide a process for image formation using the image-receiving sheet for electrophotography, an image-receiving sheet for electrophotography includes a substrate containing a base and a resin layer arranged on at least one side of the base; and at least one toner-image-receiving layer arranged on the resin layer of the substrate. The resin layer arranged between the toner-image-receiving layer and the base includes a polyethylene resin having a mass-average density of 0.935 g/cm³ or less and/or a melt flow rate MFR of 11 g/10 min. or less. In addition, an image-receiving sheet for electrophotography including a support and at least one toner-image-receiving layer over the support, the toner-image-receiving layer including a polyolefin resin.

This is a divisional of application Ser. No. 10/663,841 filed Sep. 17, 2003. The entire disclosures of the prior application, application Ser. No. 10/663,841, is hereby incorporated by reference.

### BACKGROUND OF THE INVENTION

1. Field of the Invention

The present invention relates to an image-receiving sheet for electrophotography that suppresses blocking occurrence, can fix toner images satisfactorily, has excellent glossiness and reduced brittleness and can form high-quality images. It also relates to a process for image formation using the image-receiving sheet for electrophotography.

2. Description of the Related Art

Conventional supports for use in image receiving sheets for electrophotography include, for example, raw paper, synthetic paper, synthetic resin sheets, coated paper, and laminated paper. Among them, coated paper and laminated paper are particularly advantageously used for their high quality.

The coated paper and laminated paper are produced, for example, by a solvent coating process in which a thermoplastic resin is dissolved in an organic solvent and is applied to a raw paper; an aqueous coating process in which a thermoplastic resin is formed into a latex or an aqueous solution (varnish) and is applied to a raw paper; a dry laminate process in which a thermoplastic resin is dry-laminated onto a raw paper; or a melt extrusion coating process.

However, the solvent coating process uses a deleterious organic solvent and thus adversely affects the environment.

In the aqueous coating process, the raw paper swells upon coating due to water in the latex or the aqueous solution (varnish) and loses its smoothness. For example, Japanese Patent Application Laid-Open (JP-A) No. 04-234755 proposes a support for photographic printing paper. The support is prepared by forming a coated layer of composite particles containing polyolefin resin particles and a white pigment on a raw paper, heating, melting, and solidifying the coated layer to thereby form a resin coated layer on the base. However, according to the proposed technique, the particle dispersion is applied to the support (raw paper) and is dried, thus inviting swelling of the support. The resulting support has insufficient smoothness and glossiness. In addition, the aqueous coating process cannot be applied to resins that cannot yield lattices or aqueous solutions.

When the laminated paper uses a resin having a high melt flow rate (MFR), blister occurs at a lower temperature. Accordingly, blister (swelling of a resin layer) occurs between the support and the resin layer upon heat image-fixing, thus inviting rough images. Fine and excellent image quality equivalent to silver halide film photos cannot be obtained.

Processes for forming electrophotographic images are disclosed in which a toner image is fixed with a cold releasing method after the toner image is transferred on a toner-image-receiving layer of a image-receiving sheet for electrophotography. In addition, other processes for forming electrophotographic images are disclosed in which a toner image is treated with a cold releasing method after the toner image is fixed in order to render the image smooth and glossy (See, for example, JP-A No. 04-199171, JP-A No. 04-344680, JP-A No. 2000-56602, and JP-A No. 2001-75409).

However, in these cases, each of the suggestions requires a particular thermoplastic resin layer which can receive a toner image (toner-image-receiving layer). Additionally, the toner-image-receiving layer generally employs a thermoplastic resin such as a polyester resin, styrene-acrylic resin, or the like which is the same or similar to the one that is used as a binder resin of a toner, but these thermoplastic resins have a drawback in that blocking is likely to occur.

### SUMMARY OF THE INVENTION

Accordingly, an object of the present invention is to provide an image-receiving sheet for electrophotography that suppresses blocking occurrence, allows toner images to fix satisfactorily, has excellent glossiness and reduced brittleness and can form high-quality images and to provide a process for image formation using the image-receiving sheet for electrophotography.

The present invention provides, in a first aspect, an image-receiving sheet for electrophotography including a resin layer of a support between a support and a toner-image-receiving layer, which resin layer contains a polyethylene resin having a mass-average density of 0.935 g/cm³ or less. The present invention also provides, in a second aspect, an image-receiving sheet for electrophotography including a resin layer of a support between a support and a toner-image-receiving layer, which resin layer contains a polyethylene resin having a melt flow rate (MFR) of 11 g/10 min. or less. In the third aspect of the present invention, the image-receiving sheet for electrophotography includes a support and at least one toner-image-receiving layer over the support, wherein the toner-image-receiving layer contains a polyolefin resin.

The image-receiving sheets for electrophotography according to the first and second aspects have the following advantages. By using a low-density polyethylene (LDPE) in the resin layer arranged between the base and the toner-image-receiving layer, the image-receiving sheet can allow toner images to fix satisfactorily, has a smoothed surface and thereby has higher glossiness. By using the polyethylene resin having an MFR of 11 g/10 min. or less, blister (swelling of the resin layer) does not occur at a lower temperature and does not occur between the support and the resin layer upon heat image-fixing. Thus, fine and excellent image quality can be obtained. By using the low-density polyethylene resin, the image-receiving sheet for electrophotography has reduced brittleness and can form high-quality images.

The image-receiving sheet for electrophotography in the third aspect contains a support and a toner-image-receiving layer that includes a polyolefin resin as its main component. As a result, it is possible to obtain an image-receiving sheet for electrophotography that suppresses blocking occurrence, excels in glossiness and smoothness, and has high image quality although there is no need for a special toner-image-receiving layer, and its structure is simple.

The present invention further provides a process for image formation. The process uses the image-receiving sheet for electrophotography of the present invention and includes the steps of forming a toner image on an image-forming surface of the image-receiving sheet for electrophotography; heating and pressurizing the toner image-bearing surface of the image-receiving sheet for electrophotography using a fixing belt and a fixing roller; cooling the heated and pressurized toner image-bearing surface; and removing the cooled toner image-bearing surface from the fixing belt. Thus, the releasability of the image-receiving sheet for electrophotography and the toner can be improved, offset of the image-receiving sheet for electrophotography and the toner can be prevented, the paper can thereby be fed stably even when used in an oil-less machine using no image-fixing oil. The resulting images are good, have satisfactory glossiness to a degree not conventionally attained and have excellent photographic quality.

Further objects, features and advantages of the present invention will become apparent from the following description of the preferred embodiments with reference to the attached drawing.

### BRIEF DESCRIPTION OF THE DRAWING

FIGS. 1A to 1P are views of examples of configurational aspects of the support and image-receiving sheet for electrophotography of the present invention.

FIG. 2 is a schematic view of an example of a fixing belt device for the process for forming an image of the present invention.

FIG. 3 is a schematic diagram illustrating a fixing belt for use in the process for image formation of the present invention.

FIG. 4 is a graph showing the results of glossiness of the white background in Example 4.

FIG. 5 is a graph showing the results of glossiness of the gray portion in Example 4.

FIG. 6 is a graph showing the results of glossiness of the black portion in Example 4.

FIG. 7 is a graph showing the results of relief in Example 4.

FIG. 8 is a graph showing the results of offset in Example 4.

FIG. 9 is a graph showing the results of blister in Example 4.

### DESCRIPTION OF THE PREFERRED EMBODIMENTS

### Image-receiving Sheets for Electrophotography

The image-receiving sheet for electrophotography (hereinafter may be simply referred to as “image-receiving sheet”) of the present invention comprises a support, and at least one toner-image-receiving layer arranged on the support. The support comprises a base, and a resin layer arranged on at least one side of the base. It may further comprise at least one of additional layers appropriately selected according to necessity. Such additional layers include, for example, surface protective layers, interlayers, undercoat layers, cushioning layers, charge-control or antistatic layers, reflective layers, color-control layers, storage-stability improving layers, adhesion inhibiting layers, anticurling layers, and smoothing layers. Each of these layers can have a single layer structure or a multilayer structure and it is preferable to be one of the first to the third aspect as described below.

In the first aspect, the resin layer on one side of a support to which a toner-image-receiving layer is disposed contains a polyethylene resin having a mass average density of 0.935 g/cm³ or less.

In the second aspect, the resin layer on one side of a support to which a toner-image-receiving layer is disposed contains a polyethylene resin having a melt flow rate (MFR) of 11 g/10 min. or less.

In the third aspect, the image-receiving sheet includes a support and at least one toner-image-receiving layer over the support, the toner-image-receiving layer containing a polyolefin resin.

[Support]

There is no particular limitation on the support as long as it can be resistant to the fixing temperature, and satisfies the requirements such as smoothness, whiteness index, sliding properties, frictional properties and antistatic properties, and it may be suitably selected according to the purpose. Examples of the support include raw paper, synthetic paper, synthetic resin sheet, coated paper and laminated paper and the like. These supports may have a single-layer structure, or may have a laminated structure of two or more layers.

The raw paper may be a high quality paper, for example, the paper described in Basic Photography Engineering—Silver Halide Photography, CORONA PUBLISHING CO., LTD. (1979) pp. 223-240, edited by the Institute of Photography of Japan.

The materials of the raw paper (including synthetic paper) may be those types of raw paper used as supports in the art, which can be selected from various kinds of materials without any particular limitation. Examples of the materials of the raw paper include natural pulp selected from needle-leaf trees and broadleaf trees, synthetic pulp made from plastics materials such as polyethylene, polypropylene, or the like, a mixture of the natural pulp and the synthetic pulp, and the like.

Regarding pulps used as materials for raw paper, from the viewpoint of good balance between surface flatness and smoothness of the raw paper, rigidity and dimensional stability (curl), broadleaf tree bleached kraft pulp (LBKP) is preferred. Needle-leaf bleached kraft pulp (NBKP), broadleaf tree sulfite pulp (LBSP), or the like can also be used.

The pulp can be beaten by beater of refiner.

Canadian standard freeness of the pulp is preferably 200 ml C.S.F to 440 ml C.S.F, and more preferably 250 ml C.S.F to 380 ml C.S.F, from the viewpoint of controlling contraction of paper at a paper-manufacturing step.

Various additives, for example, fillers, dry paper reinforcers, sizing agents, wet paper reinforcers, fixing agents, pH regulators or other agents, or the like may be added, if necessary, to the pulp slurry (hereafter, may be referred to as pulp paper material) which is obtained after beating the pulp.

Examples of the fillers include calcium carbonate, clay, kaolin, white clay, talc, titanium oxide, diatomaceous earth, barium sulfate, aluminum hydroxide, magnesium hydroxide, and the like.

Examples of the dry paper reinforcers include cationic starch, cationic polyacrylamide, anionic polyacrylamide, amphoteric polyacrylamide, carboxyl-modified polyvinyl alcohol, and the like.

Examples of the sizing agents include rosin derivatives such as aliphatic salts, rosin, maleic rosin or the like; paraffin wax, alkyl ketene dimer, alkenyl succinic anhydride (ASA), epoxy aliphatic amide, and the like.

Examples of the wet paper reinforcers include polyamine polyamide epichlorohydrin, melamine resin, urea resin, epoxy polyamide resin, and the like.

Examples of the fixing agents include polyfunctional metal salts such as aluminum sulfate, aluminum chloride, or the like; cationic polymers such as cationic starch, or the like.

Examples of the pH regulators include caustic soda, sodium carbonate, and the like. Examples of other agents include defoaming agents, dyes, slime control agents, fluorescent whitening agents, and the like.

Moreover, softeners can also be added if necessary. An example of the softeners is indicated on pp. 554-555 of Paper and Paper Treatment Manual (Shiyaku Time Co., Ltd.) (1980).

Treatment liquids used for sizing a surface may include water-soluble polymers, waterproof materials, pigments, dyes, fluorescent whitening agents, and the like. Examples of water-soluble polymers include cationic starch, polyvinyl alcohol, carboxyl-modified polyvinyl alcohol, carboxylmethylcellulose, hydroxylethylcellulose, cellulose sulfite, gelatin, casein, sodium polyacrylate, styrene-maleic anhydride copolymer sodium salt, sodium polystyrene sulfonate, and the like.

Examples of the waterproof materials include latex emulsions such as styrene-butadiene copolymer, ethylene-vinyl acetate copolymer, polyethylene, vinylidene chloride copolymer or the like; polyamide polyamine epichlorohydrin, and the like.

Examples of the pigments include calcium carbonate, clay, kaolin, talc, barium sulfate, titanium oxide, and the like.

Examples of the raw paper materials include the natural pulps, synthetic pulp paper, mixtures of the natural pulp and the synthetic pulp, various types of composite paper, and the like.

As for the above raw paper, to improve the rigidity and dimensional stability (curl) of the electrophotographic image-receiving paper, it is preferred that the ratio (Ea/Eb) of the longitudinal Young's modulus (Ea) and the lateral Young's modulus (Eb) is within the range of 1.5 to 2.0. If the ratio (Ea/Eb) is less than 1.5 or more than 2.0, the rigidity and curl of the electrophotographic image-receiving paper tend to deteriorate, and may interfere with paper when transported.

Base

Examples of the base include synthetic paper (synthetic paper made from, for example, polyolefins or polystyrenes), woodfree paper, art paper, (double-sided) coated paper, (double-sided) cast coat paper, mixed paper made from polyethylene or another synthetic resin pulp and natural pulp; Yankee paper, baryta paper, wallpaper, backing paper, synthetic resin- or emulsion-impregnated paper, synthetic rubber latex-impregnated paper, paper comprising a synthetic resin as an internal additive, paperboard, cellulosic fiber paper, and other paper supports; films and sheets of plastics or polymers such as polyolefins, poly(vinyl chloride), poly(ethylene terephthalate), poly(styrene methacrylate), poly(ethylene naphthalate), polycarbonate-poly(vinyl chloride), polystyrenes, polypropylenes, polyimides, celluloses such as triacetylcellulose; films and sheets obtained by subjecting these plastic films and sheets to a treatment, such as addition of a pigment such as titanium oxide for imparting white-reflecting properties; fabrics; metals, and glass.

Each of these bases can be used alone or in combination as a multilayer assemblage.

Examples of the base can also be found in JP-A No. 62-253159 (pp. 29-31 in Japanese), JP-A No. 01-61236 (pp. 14-17 in Japanese), JP-A No. 63-316848, JP-A No. 02-22651, JP-A No. 03-56955, and U.S. Pat. No. 5,001,033.

The base preferably has a high surface smoothness. More specifically, its surface roughness in terms of Oken type smoothness is preferably 210 seconds or more, and more preferably 250 seconds or more.

If the surface roughness in terms of Oken type smoothness is less than 210 seconds, the resulting images may have insufficient quality.

The Oken type smoothness as used herein is the smoothness specified in the method B, No. 5 of Japan Technical Association of the Pulp and Paper Industry (JAPAN TAPPI) and is substantially preferably around 600 seconds, and more preferably around 500 seconds.

The thickness of the base is generally from 25 μm to 300 μm, preferably from 50 μm to 260 μm, and more preferably from 75 μm to 220 μm.

The stiffness (rigidity) of the base is not specifically limited, can be appropriately selected depending on an intended purpose and are preferably near to those in bases for use in color silver halide photography when the sheet is used as an image-receiving sheet of photographic quality.

The density of the base is preferably 0.7 g/cm³ or more for better image-fixing properties.

The thermal conductivity of the base is not specifically limited, can be appropriately set depending on an intended purpose and is preferably 0.50 kcal/m.h.° C. or more as determined at a temperature of 20° C. and a relative humidity of 65% for better image-fixing properties.

The thermal conductivity can be determined, for example, by conditioning a transfer paper according to JIS P 8111 and determining the thermal conductivity of the conditioned transfer paper according to a procedure described in JP-A No. 53-66279.

The base may further comprise various additives appropriately selected depending on an intended purpose within ranges not adversely affecting the objects, operation, and advantages of the present invention. Such additives include, but are not limited to, fluorescent brightening agents (fluorescent whitening agents), conductant agents, fillers, and pigments and dyes such as titanium dioxide, ultramarine blue, and carbon black.

The base may be subjected to any of surface treatments and/or primary coatings at one or both sides thereof to thereby improve adhesion with another layer arranged on the base.

Such surface treatments include, for example, embossing or printing to form a glossy surface, a fine surface described in JP-A No. 55-26507, a matte surface or a tweed surface, corona discharge treatment, flame treatment, plasma treatment, and other activation treatments.

Each of these treatments can be employed alone or in any combination. For example, the support is subjected to the embossing and then to the activation treatment. It may be further subjected to the undercoating treatment after a surface treatment such as the activation treatment.

The base may be coated with a hydrophilic binder, a semiconductive metal oxide such as alumina sol or tin oxide, and an antistatic agent such as carbon black on its front side and/or back side. Typical disclosure of these coated bases can be found in, for example, supports in JP-A No. 63-220246.

Resin Layer Containing Polyethylene Resin

According to the first and second aspects of the image-receiving sheet for electrophtography of the present invention, the resin layer in the support arranged between the base and the toner-image-receiving layer mainly contains a polyethylene resin satisfying at least one of the following mass-average densities and the melt flow rates (MFRs).

The polyethylene resin in the resin layer arranged between the toner-image-receiving layer and the base should have a mass-average density of 0.935 g/cm³ or less. If the mass-average density exceeds 0.935 g/cm³, the resulting sheet may not allow the toner to fix satisfactorily and may not have effectively improved glossiness. The mass-average density is more preferably 0.925 g/cm³ or less.

When the resin layer between the toner-image-receiving layer and the base comprises two or more polyethylene resins, the “mass-average density” means the weighted average of the mass-average densities of the polyethylene resins.

The polyethylene resin in the resin layer arranged between the toner-image-receiving layer and the base should have a melt flow rate (MFR) of 11 g/10 min. or less, preferably from 2 to 10 g/10 min., and more preferably 4 to 8 g/10 min. If the MFR exceeds 11 g/10 min., blister may occur at a lower temperature. Accordingly, blister (swelling of the resin layer) may occur between the support and the resin layer upon heat image-fixing, thus inviting rough images. Fine and excellent image quality equivalent to silver halide film photos may not be obtained.

The MFR is determined according to a method specified in Japanese Industrial Standards (JIS) K 7210 (at 230° C., under a load of 2.16 kg).

The resin layer in the support between the toner-image-receiving layer and the base is not specifically limited, can be appropriately selected depending on an intended purpose and preferably comprises two or more polyethylene resins having different mass-average densities. Such a mixture comprising the two or more polyethylene resins is not specifically limited as long as it satisfies at least one of the requirements in the mass-average density and the MFR. Any combination of, for example, high-density polyethylenes (HDPEs), low-density polyethylenes (LDPEs), and linear low-density polyethylenes (LLDPEs) can be used.

The content of the polyethylene resin in the resin layer of the support between the toner-image-receiving layer and the base is preferably 60% by mass or more, and more preferably 70% to 90% by mass based on the total mass of the resin layer.

The resin layer of the support between the toner-image-receiving layer and the base preferably has a gelatin-containing undercoat layer on its surface for better coating of the toner-image-receiving layer on the resin layer.

The resin layer comprising the polyethylene resin can be formed by any process that is not specifically limited and can be selected depending on an intended purpose. For example, the resin layer can be formed by dry lamination of a polyethylene film on the base, coating of the polyethylene resin in a solvent, aqueous coating of a polyethylene emulsion, impregnation of the base with a polyethylene emulsion, or melt extrusion coating. For better productivity, the resin layer is preferably formed by melt extrusion coating.

The thickness of the resin layer comprising the polyethylene resin is not specifically limited, can be appropriately set depending on an intended purpose and is preferably from 1 μm to 50 μm, and more preferably from 5 μm to 35 μm.

The resin layer comprising the polyethylene resin preferably further comprises at least one of white pigments and fluorescent brightening agents according to necessity, in addition to the polyethylene resin.

The fluorescent brightening agent can be any of known compounds that have absorption in near-UV regions and emit fluorescence at 400 nm to 500 nm. Typical disclosure of such fluorescent brightening agents can be found in, for example, K. Venkataraman (Ed.) “The Chemistry of Synthetic Dyes” Vol. V, 8, Academic Press, NY (1971). Examples of the fluorescence brightening agents are stilbene compounds, coumarin compounds, biphenyl compounds, benzoxazoline compounds, naphthalimide compounds, pyrazoline compounds, and carbostyril compounds. These fluorescent brightening agents are commercially available under the trade names of Whitex PSN, PHR, HCS, PCS and B from Sumitomo Chemical Co., Ltd., Japan; and UVITEX-OB from Ciba Specialty Chemicals, Switzerland.

The white pigments include, for example, titanium dioxide, calcium carbonate, barium sulfate, and zinc white. Among them, titanium dioxide is preferred for its high masking properties.

The content of the white pigment and/or fluorescent brightening agent in the resin layer is preferably 0.1 to 8 g/m², and more preferably 0.5 to 5 g/m².

If the content is less than 0.1 g/m², the support may have excessively high transmittance. If it exceeds 8 g/m², the resulting sheet may have cracking, decreased adhesion resistance, or other problems in handling.

Toner-Image-Receiving Layer

The toner-image-receiving layer is an image-receiving layer for receiving a color or black toner to form an image. The toner-image-receiving layer receives a toner for image formation from a development drum or an intermediate transfer member by action of (static) electricity or pressure in a transfer process and fixes the toner as an image by action of, for example, heat and/or pressure in an image-fixing process. The toner-image-receiving layer mainly comprises a thermoplastic resin and contains other components.

Thermoplastic Resins

For the image-receiving sheet for electrophotography of the third aspect, a toner-image-receiving layer is disposed on at least one side of the support, the toner-image-receiving layer containing a polyolefin resin as a main component.

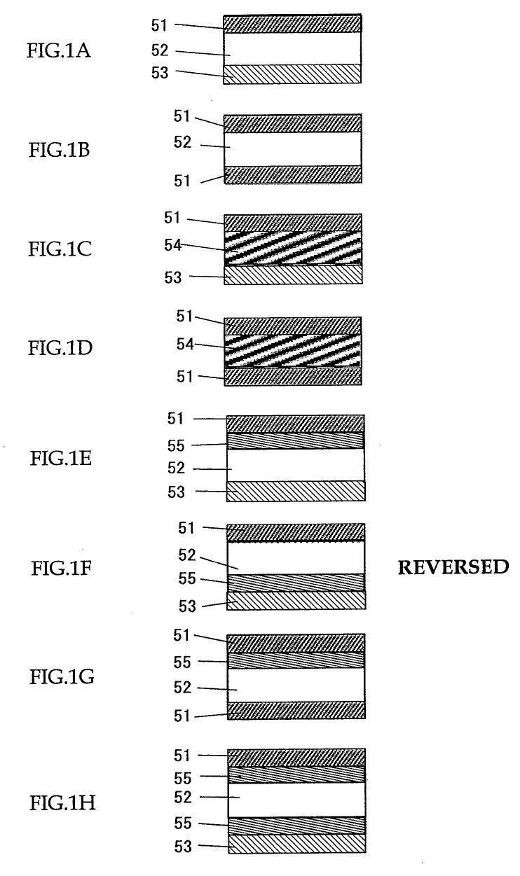

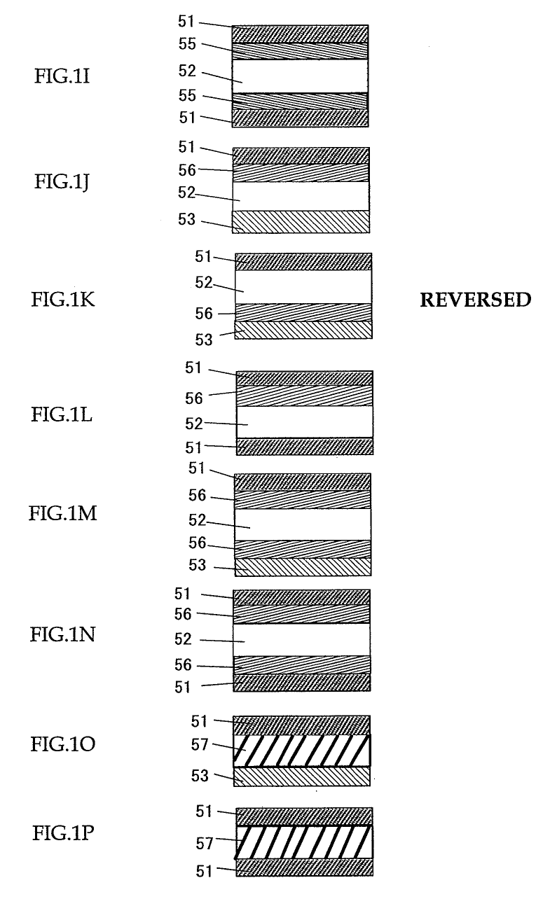

Examples of the image-receiving sheet for electrophotography in which a toner-image-receiving layer is formed over a support include Configurations I to VII as shown in FIGS. 1A to 1P, in which like reference numbers are used to designate like elements.

In Configuration I, as shown in FIG. 1A, raw paper 52 has one toner-image-receiving layer 51 disposed on one side and a resin 53 coated or laminated on the other side, or alternatively, as shown in FIG. 1B, one toner-image-receiving layer 51 on each side.

In Configuration II, as shown in FIG. 1C, synthetic paper 54 has one toner-image-receiving layer 51 disposed on one side and a resin 53 coated or laminated on the other side, or alternatively, as shown in FIG. 1D, one toner-image-receiving layer 51 on each side.

In Configuration III, as shown in FIG. 1E, one-side coated paper, which comprises raw paper 52 and one layer of coating 55 coated on one side of the raw paper 52, has one toner-image-receiving layer 51 disposed on the coated layer 55 and a resin 53 coated or laminated on the raw paper 52. The one-side coated paper may be reversed so that it has one toner-image-receiving layer 51 disposed on the raw paper 52 and a resin 53 coated or laminated on the coated layer 55, as shown in FIG. 1F. Alternatively, as shown in FIG. 1G, the one-side coated paper may have one toner-image-receiving layer 51 on each side.

In Configuration IV, as shown in FIG. 1H, two-side coated paper, which comprises raw paper 52 and two layers of coating 55 coated on each side of the raw paper 52, has one toner-image-receiving layer 51 disposed on one side and a resin 53 coated or laminated on the other side, or alternatively, as shown in FIG. 1I, one toner-image-receiving layer 51 on each side.

In Configuration V, as shown in FIG. 1J, one-side laminated paper, which comprises raw paper 52 and one laminated layer 56 laminated on one side of the raw paper 52, has one toner-image-receiving layer 51 disposed on the laminated layer 56 and a resin 53 coated or laminated on the raw paper 52. The one-side laminated paper may be reversed so that it has one toner-image-receiving layer 51 disposed on the raw paper 52 and a resin 53 coated or laminated on the laminated layer 56, as shown in FIG. 1K. Alternatively, as shown in FIG. 1L, the one-side laminated paper may have one toner-image-receiving layer 51 on each side.

In Configuration VI, as shown in FIG. 1M, two-side laminated paper, which comprises raw paper 52 and two laminated layers 56 laminated on each side of the raw paper 52, has one toner-image-receiving layer 51 disposed on one side and a resin 53 coated or laminated on the other side, or alternatively, as shown in FIG. 1N, one toner-image-receiving layer 51 on each side.

In Configuration VII, as shown in FIG. 1O, a film 57 has one toner-image-receiving layer 51 disposed on one side and a resin 53 coated or laminated on the other side, or alternatively, as shown in FIG. 1P, one toner-image-receiving layer 51 on each side.

Examples of the polyolefin resin include polyethylene, polypropylene, and mixtures thereof.

Examples of polyethylene include high density polyethylene (HDPE), low density polyethylene (LDPE), linear low density polyethylene (L-LDPE), and the like. Among these, HDPE, L-LDPE, and the like are preferable. These resins may be used alone or in combination of two or more.

To improve heat resistance, the polyolefin resin is preferably polypropylene, a blend of polypropylene and polyethylene, HDPE, a blend of HDPE and LDPE, or the like. In particular, from the viewpoint of costs, lamination applicability, and the like, it is preferable to use a blend of HDPE and LDPE.

For a blend of HDPE and LDPE, blending ratio (mass ratio) is, for example, 1/9 to 9/1. The blending ratio is preferably from 2/8 to 8/2, and more preferably from 3/7 to 7/3. In case layers of thermoplastic resin are formed on both sides of the support, the back side of the support is preferably formed using, for example, HDPE or a blend of HDPE and LDPE.

The melt index of the polyethylene for both HDPE and LDPE is preferably from 1.0 g/10 min. to 70 g/10 min., and preferably suitable for extrusion.

The amount of polyolefin resin in the toner-image-receiving layer is preferably 60% by mass or more, and more preferably from 60% by mass to 90% by mass.

Such polyolefin resin has a characteristic that although its glass transition temperature (Tg) is low, the resin suppresses blocking occurrence because its structure suppresses the interaction with other substances.

There is no particular limit for the process for forming a toner-image-receiving layer containing a polyolefin resin as a main component over a support, and it can suitably be selected according to the purpose. For example, the layer can be formed on a support by dry lamination of polyolefin film, application of polyolefin resin solution, application of polyolefin emulsion, impregnation of polyolefin emulsion, or melt extrusion coating, but from the standpoint of productivity and the like, forming by melt extrusion coating is preferable.

For the first and second aspects, thermoplastic resins are not specifically limited as long as they can deform at temperatures during, for example, image-fixing and can receive the toner. They can be appropriately selected depending on an intended purpose and are preferably similar or the same resin as the binder resin of the toner. Polyester resins, styrene resins, styrene-butyl acrylate, and other copolymer resins are often used in most of such toners, and the image-receiving sheet preferably comprise any of these polyester resins, styrene resins, styrene-butyl acrylate, and other copolymer resins more preferably in an amount of 20% by mass or more. As the thermoplastic resins, styrene-acrylic ester copolymers and styrene-methacrylic ester copolymers are also preferred.

Examples of the thermoplastic resins are (i) resins each having an ester bond, (ii) polyurethane resins and similar resins, (iii) polyamide resins and similar resins, (iv) polysulfone resins and similar resins, (v) poly(vinyl chloride) resins and similar resins, (vi) poly(vinyl butyral) and similar resins, (vii) polycaprolactone resins and similar resins, and (viii) polyolefin resins and similar resins.

The resins (i) having an ester bond include, for example, polyester resins obtained by condensation of a dicarboxylic acid component with an alcohol component. Such dicarboxylic acid components include, but are not limited to, terephthalic acid, isophthalic acid, maleic acid, fumaric acid, phthalic acid, adipic acid, sebacic acid, azelaic acid, abietic acid, succinic acid, trimellitic acid, pyromellitic acid, and other dicarboxylic acids. Each of these dicarboxylic acid components may have a sulfonic acid group, a carboxyl group, or another group substituted thereon. The alcohol components include, but are not limited to, ethylene glycol, diethylene glycol, propylene glycol, bisphenol A, diether derivatives of bisphenol A (e.g., an ethylene oxide diadduct of bisphenol A, and a propylene oxide diadduct of bisphenol A), bisphenol S, 2-ethylcyclohexyldimethanol, neopentyl glycol, cyclohexyldimethanol, glycerol, and other alcohols. Each of these alcohol components may have a hydroxyl group or another group substituted thereon. The resins (i) also include poly(methyl methacrylate), poly(butyl methacrylate), poly(methyl acrylate), poly(butyl acrylate), and other polyacryic ester resins and polymethacrylic ester resins, polycarbonate resins, poly(vinyl acetate) resins, styrene-acrylate resins, styrene-methacrylate copolymer resins, and vinyltoluene-acrylate resins.

Typical disclosure of the resins (i) can be found in, for example, JP-A No. 59-101395, JP-A No. 63-7971, JP-A No. 63-7972, JP-A No. 63-7973, and JP-A No. 60-294862.

Such polyester resins are commercially available under the trade names of, for example, Vylon 290, Vylon 200, Vylon 280, Vylon 300, Vylon 103, Vylon GK-140, and Vylon GK-130 from Toyobo Co., Ltd.; Tuftone NE-382, Tuftone U-5, ATR-2009, and ATR-2010 from Kao Corporation; Elitel UE 3500, UE 3210, and XA-8153 from Unitika Ltd.; and Polyestar TP-220, and R-188 from Nippon Synthetic Chemical Industry Co., Ltd.

The acrylic resins are commercially available under the trade names of, for example, Dianal SE-5437, SE-5102, SE-5377, SE-5649, SE-5466, SE-5482, HR-169, HR-124, HR-1127, HR-116, HR-113, HR-148, HR-131, HR-470, HR-634, HR-606, HR-607, LR-1065, LR-574, LR-143, LR-396, LR-637, LR-162, LR-469, LR-216, BR-50, BR-52, BR-60, BR-64, BR-73, BR-75, BR-77, BR-79, BR-80, BR-83, BR-85, BR-87, BR-88, BR-90, BR-93, BR-95, BR-100, BR-101, BR-102, BR-105, BR-106, BR-107, BR-108, BR-112, BR-113, BR-115, BR-116, and BR-117 from Mitsubishi Rayon Co., Ltd.; Eslec P SE-0020, SE-0040, SE-0070, SE-0100, SE-1010, and SE-1035 from Sekisui Chemical Co., Ltd.; Himer ST 95, and ST 120 from Sanyo Chemical Industries, Ltd.; and FM 601 from Mitsui Chemicals, Inc.

The poly(vinyl chloride) resins and similar resins (v) include, for example, poly(vinyl chloride) resins, poly(vinylidene chloride) resins, vinyl chloride-vinyl acetate copolymer resins, and vinyl chloride-vinyl propionate copolymer resins.

The poly(vinyl butyral) and similar resins (vi) include, for example, poly(vinyl butyral), polyol resins, as well as ethylcellulose resins, cellulose acetate resins, and other cellulosic resins. These resins (vi) are also commercially available from, for example, Denki Kagaku Kogyo Kabushiki Kaisha and Sekisui Chemical Co., Ltd. The poly(vinyl butyral) for use herein preferably comprises vinyl butyral in a content of 70% by mass or more and has an average polymerization degree of preferably 500 or more and more preferably 1000 or more. Such poly(vinyl butyral) is commercially available under the trade names of, for example, Denka Butyral 3000-1, 4000-2, 5000A, and 6000C from Denki Kagaku Kogyo Kabushiki Kaisha; and Eslec BL-1, BL-2, BL-3, BL-S, BX-L, BM-1, BM-2, BM-5, BM-S, BH-3, BX-1, and BX-7 from Sekisui Chemical Co., Ltd.

The polycaprolactone resins and similar resins (vii) further include, for example, styrene-maleic anhydride resins, polyacrylonitrile resins, polyether resins, epoxy resins, and phenol resins.

The polyolefin resins and similar resins (viii) include, for example, polyethylene resins, polypropylene resins, copolymer resins of an olefin such as ethylene or propylene with another vinyl monomer, and acrylic resins.

Each of these thermoplastic resins can be used alone or in combination. Mixtures of these thermoplastic resins and copolymers of monomers constituting the same can also be used.

The thermoplastic resin is preferably such a thermoplastic resin as to satisfy the requirements in the physical properties of a toner image receiving layer comprising the thermoplastic resin in question and is more preferably such a thermoplastic resin that can satisfy, by itself, the requirements. It is also preferred that two or more resins exhibiting different physical properties as the toner image receiving layer are used in combination.

The thermoplastic resin preferably has a molecular weight larger than that of a thermoplastic resin used in the toner. However, this relationship in molecular weight between two thermoplastic resins may not be applied to some cases. For example, when the thermoplastic resin used in the toner image receiving layer has a softening point higher than that of the thermoplastic resin used in the toner, the former thermoplastic resin may preferably have a molecular weight equivalent to or lower than that of the latter thermoplastic resin.

A mixture of resins having the same composition but different average molecular weights is also preferably used as the thermoplastic resin. The relationship in molecular weight between the thermoplastic resin used in the toner image receiving layer and that used in the toner is preferably one disclosed in JP-A No. 08-334915.

The thermoplastic resin preferably has a particle size distribution larger than that of the thermoplastic resin used in the toner.

The thermoplastic resin preferably satisfies the requirements in physical properties as disclosed in, for example, JP-A No. 05-127413, No. 08-194394, No. 08-334915, No. 08-334916, No. 09-171265, and No. 10-221877.

The thermoplastic resin for use in the toner-image-receiving layer is typically preferably at least one of water-soluble resins, water-dispersible resins, and other aqueous resins for the following reasons (i) and (ii).

(i) These aqueous resins do not invite exhaustion of an organic solvent in a coating and drying process and are thereby environment friendly and have good workability.

(ii) Most of waxes and other releasing agents cannot be significantly dissolved in solvents at room temperature and are often dispersed in a medium (water or an organic solvent) before use. Such aqueous dispersions are more stable and suitable in production processes. When an aqueous composition containing the thermoplastic resin and a wax is applied, the wax readily bleeds out on the surface of a coated layer, thus yielding the effects of the releasing agent (anti-offset properties and adhesion resistance) more satisfactorily.

The aqueous resins are not specifically limited in their compositions, bonding configurations, molecular structures, molecular weights, molecular weight distributions, shapes, and other factors and can be appropriately selected depending on an intended purpose, as long as they are water-soluble or water-dispersible resins. Examples of groups that impart hydrophilicity to polymers are sulfonic acid groups, hydroxyl groups, carboxyl groups, amino groups, amide groups, and ether groups.

Typical disclosure of the aqueous resins can be found in, for example, Research Disclosure No. 17,643, pp. 26; Research Disclosure No. 18,716, pp. 651; Research Disclosure No. 307,105, pp. 873-874; and JP-A No. 64-13546, pp. 71-75 (in Japanese).

Examples of such aqueous resins are vinylpyrrolidone-vinyl acetate copolymers, styrene-vinylpyrrolidone copolymers, styrene-maleic anhydride copolymers, water-soluble polyesters, water-soluble acrylics, water-soluble polyurethanes, water-soluble nylons (water-soluble polyamides), and water-soluble epoxy resins. Moreover, various types of gelatins may be selected according to the purpose from among liming gelatin, acid-treated gelatin and deliming gelatin wherein the content of calcium, etc., is reduced, and it is also preferable to use these in combination. Examples of water-soluble polyesters are various Pluscoats from Goo Chemical Co., Ltd. and the Finetex ES series from Dainippon Ink & Chemicals In. Examples of water-soluble acrylics are the Jurymer AT series from Nihon Junyaku Co., Ltd., Finetex 6161 and K-96 from Dainippon Ink & Chemicals Inc., and Hiros NL-1189 and BH-997L from Seiko Chemical Industries Co., Ltd.

Examples of water dispersible resins are water-dispersible type resins such as water-dispersible acrylate resin, water-dispersible polyester resin, water-dispersible polystyrene resin and water-dispersible urethane resin; and emulsions such as acrylate resin emulsion, polyvinyl acetate emulsion and SBR (styrene butadiene) emulsion. The resin can be conveniently selected from an aqueous dispersion of the aforesaid thermoplastic resins (i) to (viii), their emulsions, or their copolymers, mixtures and cation-modified derivatives, and two or more sorts can be combined.

Examples of the aforesaid water-dispersible resins in the polyester class are the Vylonal Series from Toyobo Co., Ltd, the Pesresin A Series from Takamatsu Oil & Fat Co., Ltd., the Tuftone UE Series from Kao Corporation, the WR Series from Nippon Synthetic Chemical Industry Co., Ltd., and the Elitel Series from Unitika Ltd., and in the acrylic class are the Hiros XE, KE and PE series from Seiko Chemical Industries Co., Ltd., and the Jurymer ET series from Nihon Junyaku Co., Ltd.

It is preferred that the film-forming temperature (MFT) of the polymer is above room temperature for storage before printing, and is less than 100° C. for fixing of toner particles.

The thermoplastic resin for use in the present invention is preferably a self-dispersible polyester resin emulsion satisfying the following conditions (1) to (4). This type of polyester resin emulsion is self-dispersible requiring no surfactant, is low in moisture absorbency even in an atmosphere at high humidity, exhibits less decrease in its softening point due to moisture and can thereby avoid offset in image-fixing and failures due to adhesion between sheets during storage. The emulsion is water-based and is environmentally friendly and excellent in workability. In addition, the polyester resin used herein readily takes a molecular structure with high cohesive energy. Accordingly, the resin has sufficient hardness (rigidity) during its storage but is melted with low elasticity and low viscosity during an image-fixing process for electrophotography, and the toner is sufficiently embedded in the toner-image-receiving layer to thereby form images having sufficiently high quality.

(1) The number-average molecular weight Mn is preferably from 5000 to 10000 and more preferably from 5000 to 7000.

(2) The molecular weight distribution (Mw/Mn) is preferably 4 or less, and more preferably 3 or less, wherein Mw is the weight-average molecular weight.

(3) The glass transition temperature Tg is preferably from 40° C. to 100° C. and more preferably from 50° C. to 80° C.

(4) The volume average particle diameter is preferably from 20 to 200 nm and more preferably from 40 to 150 nm.

The content of the thermoplastic resin in the toner-image-receiving layer is preferably 10% by mass or more, and more preferably 30% by mass or more.

The toner-image-receiving layer may further comprise other additives for improving its thermodynamic properties. The other additives include, for example, plasticizers, releasing agents, coloring agents, fillers, crosslinking agents, charge control agents, emulsions, and dispersions.

The plasticizers can be any of known plasticizers for resins. The plasticizers serve to control fluidizing or softening of the toner image receiving layer by action of heat and/or pressure when the toner is fixed.

Typical disclosures of the plasticizers can be found in, for example, Kagaku Binran (Chemical Handbook), ed. by The Chemical Society of Japan, Maruzen Co., Ltd. Tokyo; Plasticizer, Theory and Application, edited and written by Koichi Murai and published by Saiwai Shobo; Volumes 1 and 2 of Studies on Plasticizer, edited by Polymer Chemistry Association; and Handbook on Compounding Ingredients for Rubbers and Plastics, edited by Rubber Digest Co.

Examples of the plasticizers include, for example, esters of the following acids; phthalic, phosphoric, fatty acids, abietic, adipic, sebacic, azelaic, benzoic, butyric, epoxidized fatty acids, glycolic, propionic, trimellitic, citric, sulfonic, carboxylic, succinic, maleic, fumaric, and stearic acid; amides including aliphatic amides and sulfonamides, ethers, alcohols, lactones, poly (ethylene oxide) s (refer to JP-A No. 59-83154, No. 59-178451, No. 59-178453, No. 59-178454, No. 59-178455, No. 59-178457, No. 62-174754, No. 62-245253, No. 61-209444, No. 61-200538, No. 62-8145, No. 62-9348, No. 62-30247, No. 62-136646, and No. 2-235694). The plasticizers can be used by mixing with the resins.

Polymer plasticizers having a relatively low molecular weight can also be used herein. The molecular weight of such a plasticizer is preferably lower than that of a resin to be plasticized and is preferably 15000 or less, and more preferably 5000 or less. When these polymer plasticizers are used, those of the same kind with the resin to be plasticized are preferred. For example, low-molecular-weight polyesters are preferably used for plasticizing a polyester resin. In addition, oligomers can be used as the plasticizers. In addition to the aforementioned compounds, the plasticizers are also commercially available under the trade names of, for example, Adekacizer PN-170 and PN-1430 from Asahi Denka Kogyo Co., Ltd.; PARAPLEX G-25, G-30 and G-40 from C. P. Hall Co.; Ester Gum 8L-JA, Ester R-95, Pentalin 4851, FK 115, 4820 and 830, Luisol 28-JA, Picolastic A75, Picotex LC and Crystalex 3085 from Rika Hercules Co.

The plasticizer can be freely used so as to mitigate stress and/or strain when the toner particles are embedded in the toner-image-receiving layer. Such strain includes, for example, physical strain such as elastic force and viscosity, and strain due to material balance in, for example, molecules, principle chains and/or pendant moieties of the binder.

The plasticizer may be finely dispersed, may undergo micro-phase separation into islands-in-sea structure or may be sufficiently dissolved or miscible with other components such as a binder in the layers.

The content of the plasticizer in the toner-image-receiving layer is preferably from 0.001% to 90% by mass, more preferably from 0.1% to 60% by mass, and further preferably from 1% to 40% by mass.

The plasticizers can be used to control the slipping property leading to the improvement in the transport performance due to friction reduction, improve the anti-offset property during fixing (detachment of toner or layers onto the fixing means) or control the curling property and the charging property for a desirable latent toner image formation.

The releasing agent is incorporated into the toner-image-receiving layer so as to prevent offset of the toner-image-receiving layer. Such releasing agents are not specifically limited and can be appropriately selected, as long as they are melted or fused by heating at an image-fixing temperature, are deposited on the surface of the toner-image-receiving layer and form a layer of the releasing agent on the surface by cooling and solidifying.

The releasing agent can be at least one of silicone compounds, fluorine compounds, waxes, and matting agents. Among them, at least one selected from silicone oils, polyethylene waxes, carnauba waxes, silicone particles, and polyethylene wax particles is preferably used.

As the releasing agents, the compounds mentioned for example in “Properties and Applications of Waxes”, Revised Edition, published by Saiwai Shobo, or The Silicon Handbook published by THE NIKKAN KOGYO SHIMBUN, may be used. Further, the silicon compounds, fluorine compounds or waxes used for the toners mentioned in JP-B Nos. 59-38581, 04-32380, Japanese Patents Nos. 2838498, 2949558, JP-A Nos. 50-117433, 52-52640, 57-148755, 61-62056, 61-62057, 61-118760, 02-42451, 03-41465, 04-212175, 04-214570, 04-263267, 05-34966, 05-119514, 06-59502, 06-161150, 06-175396, 06-219040, 06-230600, 06-295093, 07-36210, 07-43940, 07-56387, 07-56390, 07-64335, 07-199681, 07-223362, 07-287413, 08-184992, 08-227180, 08-248671, 08-248799, 08-248801, 08-278663, 09-152739, 09-160278, 09-185181, 09-319139, 09-319143, 10-20549, 10-48889, 10-198069, 10-207116, 11-2917, 11-44969, 11-65156, 11-73049 and 11-194542 can also be used. Moreover, two or more sets of these compounds can be used.

Examples of silicone compounds are non-modified silicone oils (specifically, dimethyl siloxane oil, methyl hydrogen silicone oil, phenyl methyl-silicone oil, or products such as KF-96, KF-96L, KF-96H, KF-99, KF-50, KF-54, KF-56, KF-965, KF-968, KF-994, KF-995 and HIVAC F-4, F-5 from Shin-Etsu Chemical Co., Ltd.; SH200, SH203, SH490, SH510, SH550, SH710, SH704, SH705, SH7028A, SH7036, SM7060, SM7001, SM7706, SH7036, SH8710, SH1107 and SH8627 from Dow Corning Toray Silicone Co., Ltd.; and TSF400, TSF401, TSF404, TSF405, TSF431, TSF433, TSF434, TSF437, TSF450 Series, TSF451 series, TSF456, TSF458 Series, TSF483, TSF484, TSF4045, TSF4300, TSF4600, YF33 Series, YF-3057, YF-3800, YF-3802, YF-3804, YF-3807, YF-3897, XF-3905, XS69-A1753, TEX100, TEX101, TEX102, TEX103, TEX104, TSW831, from Toshiba Silicones), amino-modified silicone oils (e.g., KF-857, KF-858, KF-859, KF-861, KF-864 and KF-880 from Shin-Etsu Chemical Co., Ltd., SF8417 and SM8709 from Dow Corning Toray Silicone Co., Ltd., and TSF4700, TSF4701, TSF4702, TSF4703, TSF4704, TSF4705, TSF4706, TEX150, TEX151 and TEX154 from Toshiba Silicones), carboxyl-modified silicone oils (e.g., BY16-880 from Dow Corning Toray Silicone Co., Ltd., TSF4770 and XF42-A9248 from Toshiba Silicones), carbinol-modified silicone oils (e.g., XF42-B0970 from Toshiba Silicones), vinyl-modified silicone oils (e.g., XF40-A1987 from Toshiba Silicones), epoxy-modified silicone oils (e.g., SF8411 and SF8413 from Dow Corning Toray Silicone Co., Ltd.; TSF3965, TSF4730, TSF4732, XF42-A4439, XF42-A4438, XF42-A5041, XC96-A4462, XC96-A4463, XC96-A4464 and TEX170 from Toshiba Silicones), polyether-modified silicone oils (e.g., KF-351 (A), KF-352 (A), KF-353 (A), KF-354 (A), KF-355 (A), KF-615(A), KF-618 and KF-945 (A) from Shin-Etsu Chemical Co., Ltd.; SH3746, SH3771, SF8421, SF8419, SH8400 and SF8410 from Dow Corning Toray Silicone Co., Ltd.; TSF4440, TSF4441, TSF4445, TSF4446, TSF4450, TSF4452, TSF4453 and TSF4460 from Toshiba Silicones), silanol-modified silicone oils, methacryl-modified silicone oils, mercapto-modified silicone oils, alcohol-modified silicone oils (e.g., SF8427 and SF8428 from Dow Corning Toray Silicone Co., Ltd., TSF4750, TSF4751 and XF42-B0970 from Toshiba Silicones), alkyl-modified silicone oils (e.g., SF8416 from Dow Corning Toray Silicone Co., Ltd., TSF410, TSF411, TSF4420, TSF4421, TSF4422, TSF4450, XF42-334, XF42-A3160 and XF42-A3161 from Toshiba Silicones), fluorine-modified silicone oils (e.g., FS1265 from Dow Corning Toray Silicone Co., Ltd., and FQF501 from Toshiba Silicones), silicone rubbers and silicone particulates (e.g., SH851, SH745U, SH55UA, SE4705U, SH502 UA&B, SRX539U, SE6770 U-P, DY 38-038, DY38-047, Trefil F-201, F-202, F-250, R-900, R-902A, E-500, E-600, E-601, E-506, BY29-119 from Dow Corning Toray Silicone Co., Ltd.; Tospal 105, 120, 130, 145, 240 and 3120 from Toshiba Silicones), silicone-modified resins (specifically, olefin resins or polyester resins, vinyl resins, polyamide resins, cellulosic resins, phenoxy resins, vinyl chloride-vinyl acetate resins, urethane resins, acrylate resins, styrene-acrylate resins and their copolymerization resins modified by silicone, e.g., Diaroma SP203V, SP712, SP2105 and SP3023 from Dainichiseika Color & Chemicals Mfg. Co., Ltd.; Modepa FS700, FS710, FS720, FS730 and FS770 from NOF CORPORATION; Simac US-270, US-350, US-352, US-380, US-413, US-450, Reseda GP-705, GS-30, GF-150 and GF-300 from TOAGOSEI CO., LTD.; SH997, SR2114, SH2104, SR2115, SR2202, DCI-2577, SR2317, SE4001U, SRX625B, SRX643, SRX439U, SRX488U, SH804, SH840, SR2107 and SR2115 from Dow Corning Toray Silicone Co., Ltd., YR3370, TSR1122, TSR102, TSR108, TSR116, TSR117, TSR125A, TSR127B, TSR144, TSR180, TSR187, YR47, YR3187, YR3224, YR3232, YR3270, YR3286, YR3340, YR3365, TEX152, TEX153, TEX171 and TEX172 from Toshiba Silicones), and reactive silicone compounds (specifically, addition reaction type, peroxide-curing type and ultraviolet radiation curing type, e.g., TSR1500, TSR1510, TSR1511, TSR1515, TSR1520, YR3286, YR3340, PSA6574, TPR6500, TPR6501, TPR6600, TPR6702, TPR6604, TPR6700, TPR6701, TPR6705, TPR6707, TPR6708, TPR6710, TPR6712, TPR6721, TPR6722, UV9300, UV9315, UV9425, UV9430, XS56-A2775, XS56-A2982, XS56-A3075, XS56-A3969, XS56-A5730, XS56-A8012, XS56-B1794, SL6100, SM3000, SM3030, SM3200 and YSR3022 from Toshiba Silicones).

Examples of fluorine compounds are fluorine oils (e.g., Daifluoryl #1., # 3, #10, #20, #50, #100, Unidyne TG-440, TG-452, TG-490, TG-560, TG-561, TG-590, TG-652, TG-670U, TG-991, TG-999, TG-3010, TG-3020 and TG-3510 from Daikin Industries, Ltd.; MF-100, MF-110, MF-120, MF-130, MF-160 and MF-160E from Torchem Products; S-111, S-112, S-113, S-121, S-131, S-132, S-141 and S-145 from Asahi Glass Co., Ltd.; and, FC-430 and FC-431 from DU PONT-MITSUI FLUOROCHEMICALS COMPANY, LTD), fluororubbers (e.g., LS63U from Dow Corning Toray Silicone Co., Ltd.), fluorine-modified resins (e.g., Modepa F220, F600, F2020, FF203, FF204 and F3035 from Nippon Oils and Fats; Diaroma FF203 and FF204 from Dai Nichi Pure Chemicals; Saflon S-381, S-383, S-393, SC-101, SC-105, KH-40 and SA-100 from Asahi Glass Co., Ltd.; E-351, EF-352, EF-801, EF-802, EF-601, TFEA, TFEMA and PDFOH from Torchem Products; and THV-200P from Sumitomo 3M), fluorine sulfonic acid compound (e.g., EF-101, EF-102, EF-103, EF-104, EF-105, EF-112, EF-121, EF-122A, EF-122B, EF-122C, EF-123A, EF-123B, EF-125M, EF-132, EF-135M, EF-305, FBSA, KFBS and LFBS from Torchem Products), fluorosulfonic acid, and fluorine acid compounds or salts (specifically, anhydrous fluoric acid, dilute fluoric acid, fluoroboric acid, zinc fluoroborate, nickel fluoroborate, tin fluoroborate, lead fluoroborate, copper fluoroborate, fluorosilicic acid, fluorinated potassium titanate, perfluorocaprylic acid and ammonium perfluorooctanoate), inorganic fluorides (specifically, aluminum fluoride, potassium fluoride, fluorinated potassium zirconate, fluorinated zinc tetrahydrate, calcium fluoride, lithium fluoride, barium fluoride, tin fluoride, potassium fluoride, acid potassium fluoride, magnesium fluoride, fluorinated titanic acid, fluorinated zirconic acid, ammonium hexafluorinated phosphoric acid and potassium hexafluorinated phosphoric acid).

The waxes include, but are not limited to, synthetic hydrocarbons, modified waxes, hydrogenated waxes, and naturally occurring waxes.

Examples of synthetic hydrocarbons are polyethylene waxes (e.g., Polylon A, 393 and H-481 from Chukyo Oils and Fats, and Sanwax E-310, E-330, E-250P, LEL-250, LEL-800 and LEL-400P from Sanyo Chemical Industries, Ltd.), polypropylene waxes (e.g., Biscol 330-P, 550-P and 660-P from Sanyo Chemical Industries, Ltd.), Fischertrops wax (e.g., FT100 and FT-0070 from Japan wax), and acid amide compounds or acid imide compounds (specifically, stearic acid amides and anhydrous phthalic imides such as Cellosol 920, B-495, high micron G-270, G-110 and hydrin D-757 from Chukyo Oils and Fats).

Examples of modified waxes are amine-modified polypropylenes (e.g., QN-7700 from Sanyo Chemical Industries, Ltd.), acrylic acid-modified, fluorine-modified or olefin-modified waxes, urethane waxes (e.g., NPS-6010 and HAD-5090 from Japan Wax), and alcohol waxes (e.g., NPS-9210, NPS-9215, OX-1949 and XO-020T from Japan Wax).

Examples of hydrogenated waxes are castor oil (e.g., castor wax from Itoh Oil Chemicals Co., Ltd., castor oil derivatives (e.g., dehydrated castor oil DCO, DCO Z-1, DCO Z-3, castor oil fatty acid CO-FA, ricinoleic acid, dehydrated castor oil fatty acid DCO-FA, dehydrated castor oil fatty acid epoxy ester 4 ester, castor oil urethane acrylate CA-10, CA-20, CA-30, castor oil derivative MINERASOL S-74, S-80, S-203, S-42X, S-321, special castor oil condensation fatty acid MINERASOL RC-2, RC-17, RC-55, RC-335, special castor oil condensation fatty acid ester MINERASOL LB-601, LB-603, LB-604, LB-702, LB-703, #11 and L-164 from Itoh Oil Chemicals Co., Ltd.), stearic acid (e.g., 12-hydroxystearic acid from Itoh Oil Chemicals Co., Ltd.), lauric acid, myristic acid, palmitic acid, behenic acid, sebacic acid (e.g., sebacic acid from Itoh Oil Chemicals Co., Ltd.), undecylenic acid (e.g., undecylenic acid from Itoh Oil Chemicals Co., Ltd.), heptyl acids (heptyl acids from Itoh Oil Chemicals Co., Ltd.), maleic acid, high grade maleic oils (e.g., HIMALEIN DC-15, LN-10, 00-15, DF-20 and SF-20 from Itoh Oil Chemicals Co., Ltd.), blown oils (e.g., selbonol #10, #30, #60, R-40 and S-7 from Itoh Oil Chemicals Co., Ltd.) and synthetic waxes such as cyclopentadieneic oils (CP oil and CP oil-S from Itoh Oil Chemicals Co., Ltd.).

Preferred examples of the naturally occurring waxes are vegetable waxes, animal waxes, mineral waxes, and petroleum waxes, of which vegetable waxes are typically preferred. When an aqueous thermoplastic resin is used as the thermoplastic resin in the toner-image-receiving layer, water-dispersible waxes are specifically preferred for their higher miscibility with the aqueous thermoplastic resin.

Examples of vegetable waxes are carnauba waxes (e.g., EMUSTAR AR-0413 from Japan Wax, and Cellusol 524 from Chukyo Oils and Fats), castor oil (purified castor oil from Itoh Oil Chemicals Co., Ltd.), rape oil, soybean oil, Japan tallow, cotton wax, rice wax, sugarcane wax, candellila wax, Japan wax and jojoba oil. Among them, carnauba waxes having a melting point of 70° C. to 95° C. are preferred, since the resulting image-receiving sheet has excellent anti-offset properties and adhesion resistance, can pass through a machine smoothly, has good glossiness, invites less cracking and can form high-quality images.

The animal waxes include, but are not limited to, beeswaxes, lanolin, spermaceti waxes, whale oils, and wool waxes.

Examples of mineral waxes are natural waxes such as montan wax, montan ester wax, ozokerite and ceresin, or fatty acid esters (Sansosizer-DOA, AN-800, DINA, DIDA, DOZ, DOS, TOTM, TITM, E-PS, nE-PS, E-PO, E-4030, E-6000, E-2000H, E-9000H. TCP and C-1100, New Japan Chemical Co., Ltd.). Among them, montan waxes having a melting point of 70° C. to 95° C. are preferred, since the resulting image-receiving sheet has excellent anti-offset properties and adhesion resistance, can pass through a machine smoothly, has good glossiness, invites less cracking and can form high-quality images.

Preferred examples of petroleum waxes may for example be a paraffin wax (e.g., Paraffin wax 155, 150, 140, 135, 130, 125, 120, 115, HNP-3, HNP-5, HNP-9, HNP-10, HNP-11, HNP-12, HNP-14G, SP-0160, SP-0145, SP-1040, SP-1035, SP-3040, SP-3035, NPS-8070, NPS-L-70, OX-2151, OX-2251, EMUSTAR-0384 and EMUSTAR-0136 from Japan Wax; Cellosol 686, 428, 651-A, A, H-803, B-460, E-172, 866, K-133, hydrin D-337 and E-139 from Chukyo Oils and Fats; 125 paraffin, 125° FD, 130° paraffin, 135° paraffin, 135° H, 140° paraffin, 140° N, 145° paraffin and paraffin wax M from Nisseki Mitsubishi Petroleum), or a microcrystalline wax (e.g., Hi-Mic-2095, Hi-Mic-3090, Hi-Mic-1080, Hi-Mic-1070, Hi-Mic-2065, Hi-Mic-1045, Hi-Mic-2045, EMUSTAR-0001 and EMUSTAR-042× from Japan Wax; Cellosol 967, M, from Chukyo Oils and Fats; 55 Microwax and 180 Microwax from Nisseki Mitsubishi Petroleum), and petrolatum (e.g., OX-1749, OX-0450, OX-0650B, OX-0153, OX-261BN, OX-0851, OX-0550, OX-0750B, JP-1500, JP-056R and JP-011P from Japan Wax).

The content of the naturally occurring wax in the toner-image-receiving layer (surface layer) is preferably from 0.1 to 4 g/m², and more preferably from 0.2 to 2 g/m².

If the content is less than 0.1 g/m², sufficient anti-offset properties and adhesion resistance may not be obtained. If it exceeds 4 g/m², the resulting images may decreased quality due to excessive wax.

To obtain satisfactory anti-offset properties and to allow the sheet to pass through a machine smoothly, the melting point of the naturally occurring wax is preferably from 70° C. to 95° C., and more preferably from 75° C. to 90° C.

The matting agents include various conventional matting agents. Solid particles for use in the matting agents can be classified as inorganic particles (inorganic matting agents) and organic particles (organic matting agents).

Specifically, inorganic matting agents may be oxides (for example, silicon dioxide, titanium oxide, magnesium oxide, aluminum oxide), alkaline earth metal salts (for example, barium sulfate, calcium carbonate, magnesium sulfate), silver halides (for example, silver chloride or silver bromide), and glass.

Examples of inorganic matting agents are given for example in West German Patent No. 2529321, UK Patents Nos. 760775, 1260772, and U.S. Pat. Nos. 1,201,905, 2,192,241, 3,053,662, 3,062,649, 3,257,206, 3,322,555, 3,353,958, 3,370,951, 3,411,907, 3,437,484, 3,523,022, 3,615,554, 3,635,714, 3,769,020, 4,021,245 and 4,029,504.

The aforesaid organic matting agent contains starch, cellulose ester (for example, cellulose-acetate propionate), cellulose ether (for example, ethyl cellulose) and a synthetic resin. It is preferred that the synthetic resin is insoluble or difficultly soluble. Examples of insoluble or difficultly soluble synthetic resins include poly(meth)acrylic esters, e.g., polyalkyl(meth)acrylate and polyalkoxyalkyl(meth)acrylate, polyglycidyl(meth)acrylate), poly(meth) acrylamide, polyvinyl esters (e.g., polyvinyl acetate), polyacrylonitrile, polyolefins (e.g., polyethylene), polystyrene, benzoguanamine resin, formaldehyde condensation polymer, epoxy resins, polyamides, polycarbonates, phenolic resins, polyvinyl carbazole and polyvinylidene chloride. Copolymers which combine the monomers used in the above polymers, may also be used.

In the case of the aforesaid copolymers, a small amount of hydrophilic repeating units may be included. Examples of monomers which form a hydrophilic repeating unit are acrylic acid, methacrylic acid, α,β-unsaturated dicarboxylic acid, hydroxyalkyl(meth)acrylate, sulfoalkyl (meth)acrylate and styrene sulfonic acid.

Examples of organic matting agents are for example given in UK Patent No. 1055713, U.S. Pat. Nos. 1,939,213, 2,221,873, 2,268,662, 2,322,037, 2,376,005, 2,391,181, 2,701,245, 2,992,101, 3,079,257, 3,262,782, 3,443,946, 3,516,832, 3,539,344, 3,591,379, 3,754,924 and 3,767,448, and JP-A Nos. 49-106821, 57-14835.

Also, two or more types of solid particles may be used in conjunction as matting agents. The average particle size of the solid particles may conveniently be, for example, 1 μm to 100 μm, but is preferably 4 μm to 30 μm. The usage amount of the solid particles may conveniently be 0.01 g/m² to 0.5 g/m², but is preferably 0.02 g/m² to 0.3 g/m².

The releasing agents for use in the toner-image-receiving layer can also be derivatives, oxides, purified products, and mixtures of the aforementioned substances. These releasing agents may each have a reactive substituent.

To obtain satisfactory anti-offset properties and to allow the sheet to pass through a machine smoothly, the melting point of the releasing agent is preferably from 70° C. to 95° C., and more preferably from 75° C. to 90° C.

When an aqueous thermoplastic resin is used as the thermoplastic resin in the toner-image-receiving layer, water-dispersible releasing agents are specifically preferred for higher miscibility with the aqueous thermoplastic resin.

The content of the releasing agent in the toner-image-receiving layer is preferably from 0.1% to 10% by mass, more preferably from 0.3% to 8.0% by mass, and further preferably from 0.5% to 5.0% by mass.

Examples of colorants are optical whitening agents, white pigments, colored pigments and dyes.

The aforesaid optical whitening agent has absorption in the near-ultraviolet region, and is a compound which emits fluorescence at 400 nm to 500 nm. The various optical whitening agents known in the art may be used without any particular limitation. As this optical whitening agent, the compounds described in “The Chemistry of Synthetic Dyes” Volume V, Chapter 8 edited by KVeenRataraman can conveniently be mentioned. Specific examples are stilbene compounds, coumarin compounds, biphenyl compounds, benzo-oxazoline compounds, naphthalimide compounds, pyrazoline compounds and carbostyryl compounds. Examples of these are white furfar-PSN, PHR, HCS, PCS, B from Sumitomo Chemicals, and UVITEX-OB from Ciba-Geigy.

Examples of white pigments are the inorganic pigments (e.g., titanium oxide, calcium carbonate, etc.).

Examples of organic pigments are various pigments and azo pigments described in JP-A No. 63-44653, (e.g., azo lakes such as carmine 6B and red 2B, insoluble azo compounds such as mono-azo yellow, pyrazolo orange and Balkan orange, and condensed azo compounds such as chromophthal yellow and chromophthal red), polycyclic pigments (e.g., phthalocyanines such as copper phthalocyanine blue and copper phthalocyanine green), thioxadines such as thioxadine violet, isoindolinones such as isoindolinone yellow, surenes such as perylene, perinon, hulavanthoron and thioindigo, lake pigments (e.g., Malachite Green, Rhodamine B, Rhodamine G and Victoria Blue B), and inorganic pigments (e.g., oxides, titanium dioxide and red ocher, sulfates such as precipitated barium sulfate, carbonates such as precipitated calcium carbonates, silicates such as water-containing silicates and anhydrous silicates, metal powders such as aluminum powder, bronze powder and zinc dust, carbon black, chrome yellow and Berlin blue).

One of these may be used alone, or two or more may be used in conjunction. Of these, titanium oxide is particularly preferred as the pigment.

There is no particular limitation on the form of the pigment, but hollow particles are preferred from the viewpoint that they have excellent heat conduction properties (low heat conduction properties) during image fixing.

The various dyes known in the art may be used as the aforesaid dye.

Examples of oil-soluble dyes are anthraquinone compounds and azo compounds.

Examples of water-insoluble dyes are vat dyes such as C.I. Vat violet 1, C.I. Vat violet 2, C.I. Vat violet 9, C.I. Vat violet 13, C.I. Vat violet 21, C.I. Vat blue 1, C.I. Vat blue 3, C.I. Vat blue 4, C.I. Vat blue 6, C.I. Vat blue 14, C.I. Vat blue 20 and C.I. Vat blue 35, disperse dyes such as C.I. disperse violet 1, C.I. disperse violet 4, C.I. disperse violet 10, C.I. disperse blue 3, C.I. disperse blue 7 and C.I. disperse blue 58, and oil-soluble dyes such as C.I. solvent violet 13, C.I. solvent violet 14, C.I. solvent violet 21, C.I. solvent violet 27, C.I. solvent blue 11, C.I. solvent blue 12, C.I. solvent blue 25 and C.I. solvent blue 55.

Colored couplers used in silver halide photography may also be used to advantage.

The amount (g/m²) of colorant in the aforesaid toner-image-receiving layer (surface) is preferably 0.1 to 8 g/m², but more preferably 0.5 to 5 g/m².

If the amount of colorant is less than 0.1 g/m², the light transmittance in the toner-image-receiving layer is high, and if the amount of the aforesaid colorant exceeds 8 g/m², handling becomes more difficult due to cracks, and adhesion resistance.

Among these coloring agents, the amount of the pigment is preferably less than 40% by mass, more preferably less than 30% by mass, and further preferably less than 20% by mass based on the mass of the thermoplastic resin constituting the toner-image-receiving layer.

The filler may be an organic or inorganic filler, and reinforcers for binder resins, bulking agents and reinforcements known in the art may be used.

This filler may be selected by referring to “Handbook of Rubber and Plastics Additives” (ed. Rubber Digest Co.), “Plastics Blending Agents—Basics and Applications” (New Edition) (Taisei Co.) and “The Filler Handbook” (Taisei Co.).

As the filler, various inorganic fillers (or pigments) can be used. Examples of inorganic pigments are silica, alumina, titanium dioxide, zinc oxide, zirconium oxide, micaceous iron oxide, white lead, lead oxide, cobalt oxide, strontium chromate, molybdenum pigments, smectite, magnesium oxide, calcium oxide, calcium carbonate and mullite. Silica and alumina are particularly preferred. One of these fillers may be used alone, or two or more may be used in conjunction. It is preferred that the filler has a small particle diameter. If the particle diameter is large, the surface of the toner-image-receiving layer tends to become rough.

Silica includes spherical silica and amorphous silica. The silica may be synthesized by the dry method, wet method or aerogel method. The surface of the hydrophobic silica particles may also be treated by trimethylsilyl groups or silicone. Colloidal silica is preferred. The average mean particle diameter of the silica is preferably 4 nm to 120 nm, but more preferably 4 nm to 90 nm.

The silica is preferably porous. The average pore size of porous silica is preferably 50 nm to 500 nm. Also, the average pore volume per mass of porous silica is preferably 0.5 ml/g to 3 ml/g, for example.

Alumina includes anhydrous alumina and hydrated alumina. Examples of crystallized anhydrous aluminas which may be used are α, β, γ, δ, ξ, η, θ, κ, ρ, or χ. Hydrated alumina is preferred to anhydrous alumina. The hydrated alumina may be a monohydrate or trihydrate. Monohydrates include pseudo-boehmite, boehmite and diaspore. Trihydrates include gypsite and bayerite. The average particle diameter of alumina is preferably 4 nm to 300 nm, but more preferably 4 nm to 200 nm. Porous alumina is preferred. The average pore size of porous alumina is preferably 50 nm to 500 nm. The average pore volume per mass of porous alumina is of the order of 0.3 ml/g to 3 ml/g.

The alumina hydrate can be synthesized by the sol-gel method wherein ammonia is added to an aluminum salt solution to precipitate alumina, or by hydrolysis of an alkali aluminate. Anhydrous alumina can be obtained by dehydrating alumina hydrate by the action of heat.

It is preferred that the filler is 5 parts by mass to 2000 parts by mass, relative to the dry mass of the binder in the toner image-receiving layer where the filler is to be added.

A crosslinking agent can be added in order to adjust the storage stability or thermoplastic properties of the toner-image-receiving layer. Examples of this crosslinking agent are compounds containing two or more reactive groups in the molecule such as epoxy, isocyanate, aldehyde, active halogen, active methylene, acetylene and other reactive groups known in the art.

The crosslinking agent may also be a compound having two or more groups able to form bonds such as hydrogen bonds, ionic bonds or coordination bonds.

The crosslinking agent may be a compound known in the art such as a resin coupling agent, curing agent, polymerizing agent, polymerization promoter, coagulant, film-forming agent or film-forming assistant. Examples of coupling agents are chlorosilanes, vinylsilanes, epoxisilanes, aminosilanes, alkoxyaluminum chelates, titanate coupling agents or other agents known in the art such as those mentioned in “Handbook of Rubber and Plastics Additives” (ed. Rubber Digest Co.).

The charge control agents can be used for controlling transfer and attachment of the toner, and for preventing adhesion of the image-receiving sheet due to charging.

The charge control agent may be any charge control agent known in the art, i.e., surfactants such as cationic surfactants, anionic surfactants, amphoteric surfactants, non-ionic surfactants, and polymer electrolytes or electroconducting metal oxides.

Examples of the surfactants are cationic charge inhibitors such as quaternary ammonium salts, polyamine derivatives, cation-modified polymethylmethacrylate, cation-modified polystyrene, anionic charge inhibitors such as alkyl phosphates and anionic polymers, or non-ionic charge inhibitors such as polyethylene oxide. When the toner has a negative charge, cationic charge inhibitors and non-ionic charge inhibitors are preferred.

Examples of electroconducting metal oxides are ZnO, TiO₂, SnO₂, Al₂O₃, In₂O₃, SiO₂, MgO, BaO and MoO₃. These electroconducting metal oxides may be used alone, or they may be used in the form of a complex oxide. Also, the metal oxide may contain other elements, for example ZnO may contain Al or In, TiO₂ may contain Nb or Ta, and SnO₂ may contain Sb, Nb or halogen elements (doping).

The materials used to obtain the toner-image-receiving layer of the present invention may also contain various additives to improve stability of the output image or improve stability of the toner-image-receiving layer itself. Examples of additives are antioxidants, age resistors, degradation inhibitors, anti-ozone degradation inhibitors, ultraviolet light absorbers, metal complexes, light stabilizers or preservatives.

Examples of antioxidants are chroman compounds, coumarane compounds, phenol compounds (e.g., hindered phenols), hydroquinone derivatives, hindered amine derivatives and spiroindan compounds. Antioxidants are given for example in JP-A No. 61-159644.

Examples of age resistors are given in “Handbook of Rubber and Plastics Additives”, Second Edition (1993, Rubber Digest Co.), p 76-121.

Examples of ultraviolet light absorbers are benzotriazo compounds (U.S. Pat. No. 3,533,794), 4-thiazolidone compounds (U.S. Pat. No. 3,352,681), benzophenone compounds (JP-A No. 46-2784) and ultraviolet light absorbing polymers (JP-A No. 62-260152).

Examples of metal complexes are given in U.S. Pat. Nos. 4,241,155, 4,245,018, 4,254,195, and JP-A Nos. 61-88256, 62-174741, 63-199248, 01-75568, 01-74272.

Photographic additives known in the art may also be added to the material used to obtain the toner-image-receiving layer as described above. Examples of photographic additives are given in the Journal of Research Disclosure (hereafter referred to as RD) No. 17643 (December 1978), No. 18716 (November 1979) and No. 307105 (November 1989), the relevant sections being summarized below.

| Type of additive | RD17643 | RD18716 | RD307105 |
|---|---|---|---|
| 1. Whitener | p 24 | p 648, right-hand | p 868 |
| | | column | |
| 2. Stabilizer | pp. 24-25 | p 649, right-hand | pp. 868-870 |
| | | column | |
| 3. Light absorbers | pp. 25-26 | p 649, right-hand | p 873 |
| (ultraviolet ray | | column | |
| absorbers) | | | |
| 4. Pigment image | p 25 | p 650, right-hand | p 872 |
| stabilizers | | column | |
| 5. Film-hardening | p 26 | p 651, left-hand | pp. 874-875 |
| agents | | column | |
| 6. Binders | p 26 | p 651, left-hand | pp. 873-874 |
| | | column | |
| 7. Plasticizers, | p 27 | p 650, right-hand | p 876 |
| lubricants | | column | |
| 8. Coating assistants | pp. 26-27 | p 650, right-hand | pp. 875-876 |
| (surfactants) | | column | |
| 9. Antistatic agents | p 27 | p 650, right-hand | pp. 867-877 |
| | | column | |
| 10. Matting agents | | | pp. 878-879 |

The toner-image-receiving layer is prepared by applying a coating composition containing a polymer for use in the toner-image-receiving layer using, for example, a wire coater, and drying the coated layer. The coating composition is prepared, for example, by dissolving or homogeneously dispersing a thermoplastic polymer, and additives such as a plasticizer in an organic solvent such as alcohols and ketones. Organic solvents for use herein include, but are not limited to, methanol, isopropyl alcohol, and methyl ethyl ketone. If the polymer for use in the toner-image-receiving layer is soluble in water, the toner-image-receiving layer can be prepared by applying an aqueous solution of the polymer onto the support. If not, the toner-image-receiving layer can be prepared by applying an aqueous dispersion of the polymer onto the support.

The film-forming temperature of the polymer for use in the present invention is preferably room temperature or higher for better storage before printing, and is preferably 100° C. or lower for better image-fixing of the toner particles.

The toner-image-receiving layer of the present invention is coated so that the coating mass after drying is for example 1 to 20 g/m², but preferably 4 to 15 g/m². There is no particular limitation on the thickness of the toner-image-receiving layer, but it is preferably 1 μm to 50 μm and more preferably 2 μm to 30 μm.

Physical Properties of Toner-Image-Receiving Layer

The 180-degree peel strength of the toner-image-receiving layer with a fixing member is preferably 0.1 N/25-mm or less, and more preferably 0.041 N/25-mm or less at an image-fixing temperature. The 180-degree peel strength can be determined according to a method specified in JIS K 6887 using a surface material of the fixing member.

It is preferred that the toner-image-receiving layer has a high degree of whiteness. This whiteness is measured by the method specified in JIS P 8123, and is preferably 85% or more. It is preferred that the spectral reflectance is 85% or more in the wavelength region of 440 nm to 640 nm, and that the difference between the maximum spectral reflectance and minimum spectral reflectance in this wavelength range is within 5%. Further, it is preferred that the spectral reflectance is 85% or more in the wavelength region of 400 nm to 700 nm, and that the difference between the maximum spectral reflectance and minimum spectral reflectance in this wavelength range is within 5%.

Specifically, regarding the whiteness, the L* value is preferably 80 or higher, preferably 85 or higher and still more preferably 90 or higher in a CIE 1976 (L*a*b*) color space. The tone of the white color should preferably be as neutral as possible. Regarding the whiteness tone, the value of (a*)²+(b*)² is preferably 50 or less, more preferably 18 or less and still more preferably 5 or less in a (L*a*b*) space.

It is preferred that the toner-image-receiving layer has high gloss. The gloss is 45, preferably 60 or higher, more preferably 75 or higher and still more preferably 90 or higher over the whole range from white where there is no toner, to black where there is maximum density.

However, the gloss is preferably less than 110. If it exceeds 110, the image has a metallic appearance which is undesirable.

Gloss may be measured based on JIS Z 8741.

It is preferred that the toner-image-receiving layer has a high smoothness. The arithmetic mean roughness (Ra) is preferably 3 μm or less, more preferably 1 μm or less and still more preferably 0.5 μm or less over the whole range from white where there is no toner, to black where there is maximum density.

Arithmetic mean roughness may be measured based on JIS B 0601, JIS B 0651 and JIS B 0652.

It is preferred that the toner-image-receiving layer has one of the following physical properties, more preferred that it has several of the following physical properties, and most preferred that it has all of the following physical properties.

(1) The melting temperature Tm of the toner-image-receiving layer is preferably 30° C. or higher and [(Tm of the toner)+20° C.] or lower.

(2) The temperature at which the viscosity of the toner-image-receiving layer is 1×10⁵ CP is 40° C. or higher and lower than that of the toner.

(3) The storage modulus G′ of the toner-image-receiving layer is preferably from 1×10² Pa to 1×10⁵ Pa and the loss modulus G″) thereof is preferably from 1×10² Pa to 1×10⁵ Pa at an image-fixing temperature.

(4) The loss tangent G″/G′ as the ratio of the loss modulus G″ to the storage modulus G′ of the toner-image-receiving layer at an image-fixing temperature is preferably from 0.01 to 10.

(5) The storage modulus G′ of the toner-image-receiving layer at an image-fixing temperature preferably falls in a range of −50 to +2500 of the storage modulus G″ of the toner at the image-fixing temperature.

(6) A melted toner forms an inclination with the toner-image-receiving layer of preferably 50 degrees or less and more preferably 40 degrees or less.

The toner-image-receiving layer preferably also satisfies the physical properties given in Japanese Patent No. 2788358, and JP-A Nos. 07-248637, 08-305067 and 10-239889.

It is preferred that the surface electrical resistance of the toner-image-receiving layer is within the range of 1×10⁶-1×10¹⁵ Ω/cm² (under conditions of 25° C., 65% RH)

If the surface electrical resistance is less than 1×10⁶ Ω/cm², the toner amount transferred to the toner-image-receiving layer is insufficient, and the density of the toner image obtained may be too low. On the other hand, if the surface electrical resistance exceeds 1×10¹⁵ Ω/cm², more charge than necessary is produced during transfer, toner is transferred insufficiently, image density is low and static electricity develops causing dust to adhere during handling of the image-receiving sheet for electrophotography, or misfeed, overfeed, discharge marks or toner transfer dropout may occur.

Also, the surface electrical resistance of the surface on the opposite side of the carrier to the toner-image-receiving layer is preferably 5×10⁸ to 3.2×10¹⁰ Ω/cm², and more preferably 1×10⁹ to 1×10¹ Ω/cm².

The aforesaid surface electrical resistances were measured based on JIS K 6911. The sample was left with air-conditioning for 8 hours or more at a temperature of 20° C. and humidity 65%. Measurements were made using an Advantest Ltd. R8340 under the same environmental conditions after passing a current for 1 minute at an applied voltage of 100V.

In the image-receiving sheet for electrophotography, other layers other than the toner-image-receiving layer may for example include a surface protection layer, back layer, contact improving layer, intermediate layer, underlayer, cushion layer, charge regulating (inhibiting) layer, reflecting layer, color toner adjusting layer, storage improving layer, anti-sticking layer, anti-curl layer and smoothing layer. These layers may be used alone, or two or more may be used in combination.

There is no particular limitation on the thickness of the electrostatic image-receiving sheet of the present invention, which may be suitably selected according to the purpose, but it is for example preferably 50 μm to 350 μm, and more preferably 100 μm to 280 μm.

Toner

In the electrostatic image-receiving sheet of the present invention, the toner-image-receiving layer receives toner during printing or copying.

The toner contains at least a binder resin and a colorant, but may contain releasing agents and other components as necessary.

Toner Binder Resin

Examples of the toner binder resin are styrenes such as styrene or parachlorostyrene; vinyl esters such as vinyl naphthalene, vinyl chloride, vinyl bromide, vinyl fluoride, vinyl acetate, vinyl propioniate, vinyl benzoate and vinyl butyrate; methylene aliphatic carboxylates such as methyl acrylate, ethyl acrylate, n-butyl acrylate, isobutyl acrylate, dodecyl acrylate, n-octyl acrylate, 2-chloroethyl acrylate, phenyl acrylate, methyl α-chloroacrylate, methyl methacrylate, ethyl methacrylate and butyl acrylate; vinyl nitriles such as acryloniotrile, methacrylonitrile and acrylamide; vinyl ethers such as vinyl methyl ether, vinyl ethyl ether and vinyl isobutyl ether; N-vinyl compounds such as N-vinyl pyrrole, N-vinylcarbazole, N-vinyl indole and N-vinyl pyrrolidone; and vinyl carboxylic acids such as methacrylic acid, acrylic acid and cinnamic acid. These vinyl monomers may be used alone, or their copolymers may be used. In addition, various polyesters may be used, and various waxes may be used in conjunction.

Of these resins, it is preferable to use a resin of the same type as the resin used for the toner image-receiving television layer of the present invention.

Toner Colorants

The colorants generally used in the art can be used without limitation. Examples are carbon black, chrome yellow, Hanzer yellow, benzidine yellow, thuren yellow, quinoline yellow, permanent orange GTR, pyrazolone orange, Balkan orange, watch young red, permanent red, brilliant carmin 3B, brilliant carmin 6B, dippon oil red, pyrazolone red, lithol red, rhodamine B lake, lake red C, rose bengal, aniline blue, ultramarine blue, chalco oil blue, methylene blue chloride, phthalocyanine blue, phthalocyanine green and malachite green oxalate. Various dyes may also be added such as acridine, xanthene, azo, benzoquinone, azine, anthraquinone, thioindigo, dioxadine, thiadine, azomethine, indigo, thioindigo, phthalocyanine, aniline black, polymethane, triphenylmethane, diphenylmethane, thiazine, thiazole and xanthene. These colorants may be used alone, or plural colorants may be used together.

It is preferred that the amount of colorant is within the range of 2-8 mass %. If the amount of colorant is more than 2 mass %, the coloration does not become weaker, and if it is less than 8 mass %, transparency is not lost.

Toner Releasing Agent

The releasing agent may in principle be any of the waxes known in the related art, but polar waxes containing nitrogen such as highly crystalline polyethylene wax of relatively low molecular weight, Fischertropsch wax, amide wax and urethane wax are particularly effective. For polyethylene wax, it is particularly effective if the molecular weight is less than 1000, but a range of 300-1000 is more preferred.

Compounds containing urethane bonds have a solid state due to the strength of the cohesive force of the polar groups even if the molecular weight is low, and as the melting point can be set high in view of the molecular weight, they are convenient. The preferred range of molecular weight is 300-1000. The starting materials may be selected from various combinations such as a di-isocyanate acid compound with a mono-alcohol, a mono-isocyanic acid with a mono-alcohol, a dialcohol with a mono-isocyanic acid, a tri-alcohol with a mono-isocyanic acid, and a tri-isocyanic acid compound with a mono-alcohol. To prevent increase of molecular weight, it is preferred to use a combination of compounds with polyfunctional groups and monofunctional groups, and it is important to use equivalent amounts of functional groups.

Among the starting materials, examples of mono-isocyanic acid compounds are dodecyl isocyanate, phenyl isocyanate and its derivatives, naphthyl isocyanate, hexyl isocyanate, benzyl isocyanate, butyl isocyanate and allyl isocyanate.

Examples of di-isocyanic acid compounds are tolylene di-isocyanate, 4,4′ diphenylmethane di-isocyanate, toluene di-isocyanate, 1,3-phenylene di-isocyanate, hexamethylene di-isocyanate, 4-methyl-m-phenylene di-isocyanate and isophorone di-isocyanate.

Examples of mono-alcohols which may be used are very ordinary alcohols such as methanol, ethanol, propanol, butanol, pentanol, hexanol and heptanol.

Among the starting materials, examples of di-alcohols are numerous glycols such as ethylene glycol, diethylene glycol, triethylene glycol, trimethylene glycol; and examples of tri-alcohols are trimethylol propane, triethylol propane and trimethanolethane, but the invention is not necessarily limited this range.

These urethane compounds may be mixed with the resin or colorant during kneading as in the case of an ordinary releasing agent, and used also as a kneaded, crushed toner. Further, in the case of an emulsion polymerization cohesion scorification toner, they may be dispersed in water together with an ionic surfactant, polymer acid or polymer electrolyte such as a polymer base, heated above the melting point, and converted to fine particles by applying an intense shear in a homogenizer or pressure discharge dispersion machine to manufacture a releasing agent particle dispersion of 1 μm or less, which can be used together with a resin particle dispersion or colorant dispersion.

Toner Other Components

The toner may also contain other components such as internal additives, charge control agents and inorganic particles. Examples of internal additives are metals such as ferrite, magnetite, reduced iron, cobalt, nickel and manganese, alloys or magnetic bodies such as compounds containing these metals.

The various charge control agents which are generally used may also be employed here, such as quaternary ammonium salts, nigrosine compounds, dyes from complexes of aluminum, iron and chromium, or triphenylmethane pigments. Materials which are difficulty soluble in water are preferred from the viewpoint of control of ionic strength which affects cohesion and stability during melting, and of less waste water pollution.

The inorganic fine particles may be any of the external additives for toner surfaces generally used, such as silica, alumina, titania, calcium carbonate, magnesium carbonate or tricalcium phosphate, it being preferred to disperse these with an ionic surfactant, polymer acid or polymer base.

Surfactants can also be used for emulsion polymerization, seed polymerization, pigment dispersion, resin particle dispersion, releasing agent dispersion, cohesion or stabilization thereof. Examples are anionic surfactants such as sulfuric acid ester salts, sulfonic acid salts, phosphoric acid esters or soaps, and cationic surfactants such as amine salts and quaternary ammonium salts. It is also effective to use non-ionic surfactants such as polyethylene glycols, alkylphenol ethylene oxide additives or polybasic alcohols. These may generally be dispersed by a rotary shear homogenizer or a ball mill, sand mill or dyno mill containing the media.

The toner may also contain an external additive if necessary. Examples of this additive are inorganic powders and organic particles. Examples of inorganic particles are SiO₂, TiO₂, Al₂O₃, CuO, ZnO, SnO₂, Fe₂O₃, MgO, BaO, CaO, K₂O, Na₂O, ZrO₂, CaO—SiO₂, K₂O—(TiO₂)ₙ, Al₂O₃-2SiO₂, CaCO₃, MgCO₃, BaSO₄ and MgSO₄. Examples of organic particles are fatty acids and their derivatives, powdered metal salts thereof, and resin powders of fluorine resins, polyethylene resin and acrylic resins. The average particle diameter of these powders may for example be 0.01 μm to 5 μm, but is preferably 0.1 μm to 2 μm.

There is no particular limitation on the method of manufacturing the toner, but it is preferably manufactured by a method comprising the steps of (i) forming cohesive particles in a dispersion of resin particles to manufacture a cohesive particle dispersion, (ii) adding a fine particle dispersion to the aforesaid cohesive particle dispersion so that the fine particles adhere to the cohesive particles, thus forming adhesion particles, and (iii) heating the aforesaid adhesion particles which melt to form toner particles.

Toner Physical properties

It is preferred that the volume average particle diameter of the toner is from 0.5 μm to 10 μm.

If the volume average particle diameter of the toner is too small, it may have an adverse effect on handling of the toner (supplementation, cleaning properties and flow properties), and particle productivity may decline. On the other hand, if the volume average particle damage is too large, it may have an adverse effect on image quality and resolution due to granularity and transfer properties.

It is preferred that the toner satisfies the aforesaid toner volume average particle diameter range, and that the volume average particle size distribution index (GSDv) is 1.3 or less.

It is preferred that the ratio (GSDv/GSDn) of the volume average particle size distribution index (GSDv) and number average particle size distribution index (GSDn) is at least 0.95.

It is preferred that the toner of the present invention satisfies the aforesaid volume average particle diameter range, and that the average value of the shape coefficient represented by the following equation is 1.00-1.50.
Shape coefficient=(π×L²)/(4×S)

(where, L is the maximum length of the toner particles, and S is the projection surface area of a toner particle).

If the toner satisfies the above conditions, it has a desirable effect on image quality, and in particular, granularity and resolution. Also, there is less risk of dropout and blur accompanying transfer, and less risk of adverse effect on handling properties even if the average particle diameter is small.

The storage modulus G′ (measured at an angular frequency of 10 rad/sec) of the toner itself at 150° C. is 10 to 200 Pa, which is convenient for improving image quality and preventing offset in the fixing step.

Processes for Image Formation

The toner is transferred onto the image-receiving sheet for electrophotography of the present invention, is fixed on the toner-image-receiving layer of the image-receiving sheet and thereby forms an image.

According to a first aspect of the process for image formation of the present invention, a toner image is formed on the aforesaid image-receiving sheet for electrophotography, the imaging surface of the image-receiving sheet for electrophotography is heated and pressed by a fixing belt and a roller, cooled, and peeled away from the fixing belt.

According to a second aspect of the image forming process of the present invention, a toner image is formed on the aforesaid image-receiving sheet for electrophotography, fixed by a heating roller, and the imaging surface of the image-receiving sheet for electrophotography is then heated and pressed by a fixing belt and roller, cooled, and peeled away from the fixing belt.

In the image forming processes according to the first and second aspects, it is preferred that the image-receiving sheet is heated and pressurized at a temperature of 80° C. or higher and lower than 110° C. using the fixing belt and fixing roller and is removed from the fixing belt at a temperature of 80° C. or lower. Under these conditions, the image-receiving sheet is heated and pressurized so that the polyolefin resin layer in the image-receiving sheet is softened and deformed by action of pressure, but blister does not occur, and the image-receiving sheet so that the polyolefin resin layer is solidified. The resulting toner-image-receiving layer can have satisfactory water resistance and surface smoothness and have good glossiness.

The transfer method may be a method generally used for electronic transfer, e.g., the direct transfer method wherein the toner image formed on the developing roller is transferred directly to an image-receiving material, and the intermediate transfer belt method wherein the image is first transferred to an intermediate transfer belt or the like, and then to the image-receiving material. From the viewpoint of environmental stability and high image quality, the intermediate transfer belt method is preferred.

Regarding the image-receiving sheet for electrophotography of the present invention, the toner transferred to the image-receiving material is fixed on the image-receiving material using an electrophotographic apparatus comprising a fixing belt. The belt fixing method may for example be the oilless type as described in JP-A No. 11-352819, or the method wherein a second transfer and fixing are realized simultaneously as described in JP-A Nos. 11-231671 and 05-341666. The electrophotographic apparatus comprising a fixing belt according to the present invention may be an electrophotographic apparatus comprising for example at least a heating and pressurizing part which can melt and pressurize the toner, a fixing belt which can transport the image-receiving material with toner adhering while in contact with the toner-image-receiving layer, and a cooling part which can cool the heated image-receiving material while it is still adhering to the fixing belt. By using the image-receiving sheet for electrophotography comprising the toner-image-receiving layer in the electrophotographic apparatus comprising the fixing belt, toner adhering to the toner-image-receiving layer is fixed in fine detail without spreading into the image-receiving material, and the molten toner is cooled/solidified while adhering closely to the fixing belt. The toner is received while it is completely embedded in the toner-image-receiving layer. Therefore, there are no image discrepancies, and a glossy, smooth toner image is obtained.

The image-receiving sheet for electrophotography formed in the present invention is particularly suitable for imaging by the oilless belt fixing method, and it permits a large improvement of offset. However, other image forming processes may also likewise be used.

For example, by using the image-receiving sheet for electrophotography of the present invention, a full-color image can easily be formed while improving image quality and preventing cracks. A full-color image can be formed using an electrophotographic apparatus capable of forming full-color images. An ordinary electrophotographic apparatus comprises an image-receiving paper transport part, latent image-forming part, and developing part disposed in the vicinity of the latent image forming part. Depending on the type, it may also comprise a latent image-forming part in the center of the apparatus and a toner image intermediate transfer part in the vicinity of the image-receiving paper transport part.

To improve image quality, adhesive transfer or heat assistance transfer may be used instead of the electrostatic transfer or bias roller transfer, or in conjunction therewith. Specific details of these methods are given for example in JP-A Nos. 63-113576 and 05-341666. It is particularly preferred to use an intermediate transfer belt in the heat assistance transfer method. Also, it is preferred to provide a cooling apparatus for the intermediate belt after toner transfer or in the latter half of transfer to the image-receiving sheet for electrophotography. Due to this cooling apparatus, the toner (toner image) is cooled to the softening temperature of the binder resin or below the glass transition temperature of the toner, hence the image is transferred to the image-receiving sheet for electrophotography efficiently and can be peeled away from the intermediate belt.

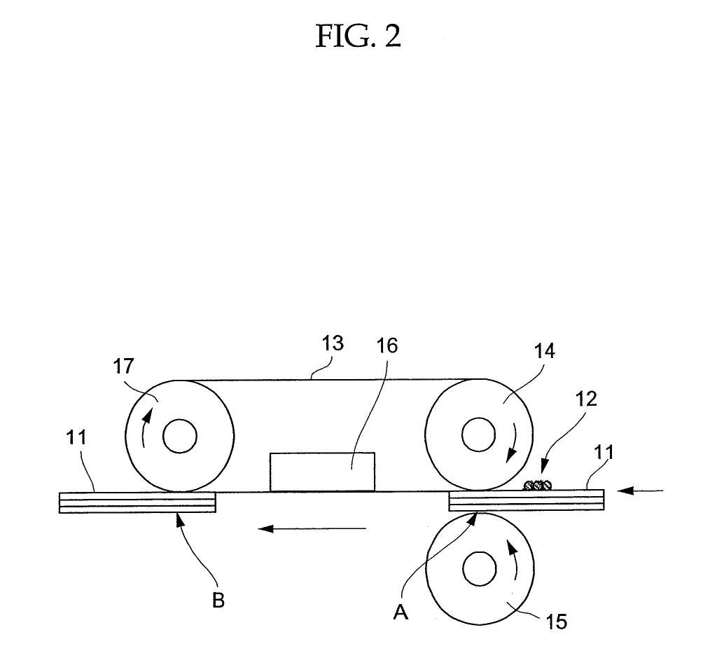

Fixing is an important step which influences the gloss and smoothness of the final image. The fixing method may be fixing by a heat and pressure roller, or belt fixing using a belt, but from the viewpoint of image quality such as gloss and smoothness, belt fixing is preferred. Belt fixing methods known in the art include for example an oil-less type of belt fixing described in JP-A No. 11-352819, and the method wherein second transfer and fixing are realized simultaneously described in JP-A Nos. 11-231671 and 05-341666. Further, a first fixing may also be performed by a heat roller before the pressurizing and heating by the fixing belt and fixing roller. Hereafter, an example of an apparatus for image formation having a typical fixing belt will be described referring into FIG. 2. It should however be understood that the present invention is not limited to the aspect shown in FIG. 2

First, a toner 12 is transferred onto an image-receiving sheet for electrophotography 11 by the apparatus for image formation, (which is not shown in FIG. 2). The image-receiving sheet 11 to which the toner 12 adheres is transferred to a point A by a transferring equipment (which is not shown in FIG. 2), and is transported between a heat roller 14 and pressure roller 15, and is thereby heated and pressurized to a temperature (fixing temperature) and to pressure at which a toner-image-receiving layer of the image-receiving sheet for electrophotography 11, or the toner 12, are sufficiently softened.

Herein, the fixing temperature means the temperature of the toner-image-receiving layer surface measured at the position of the heat roller 14, pressure roller 15 and nip part at the point A, and is for example 80° C. to 190° C., and more preferably 100° C. to 170° C. The pressure means the pressure of the toner-image-receiving layer surface measured at the heat roller 14, pressure roller 15 and nip part, and is for example 1 kgf/cm² to 10 kgf/cm², and more preferably 2 kgf/cm² to 7 kgf/cm². While the image-receiving sheet for electrophotography 11 is thus heated and pressurized, and is transported to the cooling device 16 by a fixing belt 13, a releasing agent (not shown in FIG. 2), which was dispersed in the toner-image-receiving layer, is sufficiently heated so as to become melted, and is transferred onto a surface of the toner-image-receiving layer. The transferred releasing agent forms a layer (film) of releasing agent on the surface of the toner-image-receiving layer. Thereafter, the image-receiving sheet for electrophotography 11 is transported to the cooling device 16 with the fixing belt 13, and is cooled for example to the softening point or lower or to the glass transition temperature plus 10° C. or lower of the polymer in the toner-image-receiving layer and/or the binder resin used in the toner, which is preferably 20° C. to 80° C., and more preferably room temperature (25° C.). In this way, the layer (film) of releasing agent disposed on the surface of the toner-image-receiving layer is cooled and solidified, and the layer of the releasing agent is formed due to change in the releasing agent, inside the toner-image-receiving layer.

The cooled image-receiving sheet for electrophotography 11 is then transported to a point B by the fixing belt 13, and the fixing belt 13 is spanned around and is rotated by a tension roller 17. Therefore, at the point B, the image-receiving sheet for electrophotography 11 and fixing belt 13 become separated. It is preferred that a diameter of the tension roller be small, so that the image-receiving sheet for electrophotography separates from the belt with its own rigidity (strength).

The surface of the fixing belt may receive a surface treatment of a silicone compound, fluorine compound or a combination thereof to prevent peeling of the toner and prevent offset of toner components. Also, it is preferred to provide a belt cooling apparatus in the latter half of fixing, which ameliorates the peeling of the image-receiving sheet for electrophotography. The cooling temperature is preferably below the softening point, or below the glass transition temperature, of the toner binder resin and/or the polymer in the toner-image-receiving layer of the image-receiving sheet for electrophotography. On the other hand, in the first stage of fixing, the temperature of the toner-image-receiving layer or toner of the image-receiving sheet for electrophotography must be raised to the temperature at which they become sufficiently softened. More specifically, the image-receiving sheet is practically preferably cooled to 30° C. to 80° C. The image-receiving sheet is preferably heated to 100° C. to 180° C. in early stages of the image-fixing process.

Herein, it is convenient if the fixing belt used in the imaging apparatus is an endless belt formed from a material such as for example polyimide, electroplated nickel or aluminum.

It is preferred to form a thin film comprising at least one material selected from silicone rubber, fluorinated rubber, silicone resin or fluorinated resin on the surface of the fixing belt. Of these, it is preferred to provide a layer of fluorocarbon siloxane rubber on the surface of the fixing belt, or provide a layer of silicone rubber on the surface of the fixing belt and then provide a layer of fluorocarbon siloxane rubber on the surface of the silicone rubber.

It is preferred that the fluorocarbon siloxane rubber has a perfluoroalkyl ether group and/or a perfluoroalkyl group in the main chain.

As the fluorocarbon siloxane rubber, a curing material comprising a fluorocarbon siloxane rubber composition containing the components (A) to (D) below are preferred.

(A) a fluorocarbon polymer having a fluorocarbon siloxane of the following general formula 1 below as its main component, and containing aliphatic unsaturated groups, (B) an organopolysiloxane and/or fluorocarbon siloxane containing two or more SiH groups in the molecule, and 1 to 4 times the molar amount of SiH groups more than the amount of aliphatic unsaturated groups in the aforesaid fluorocarbon siloxane rubber, (C) a filler, and (D) an effective amount of catalyst.

The fluorocarbon polymer of component (A) comprises a fluorocarbon siloxane containing a repeating unit represented by the following general formula 1 as its main component, and contains aliphatic unsaturated groups.

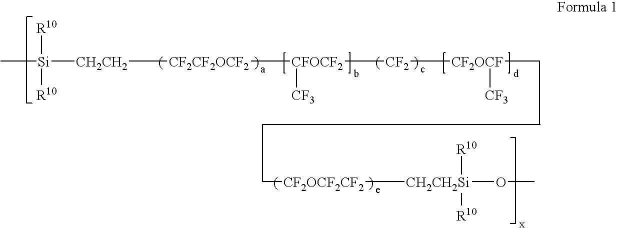

In the aforesaid formula 1, R¹⁰ is a non-substituted or substituted monofunctional hydrocarbon group preferably containing 1-8 carbon atoms, preferably an alkyl group containing 1-8 carbon atoms or an alkenyl group containing 2 to 3 carbon atoms, and particularly preferably methyl. a, e are respectively 0 or 1, b, d are respectively integers in the range 1 to 4, and c is an integer in the range 0 to 8. x is an integer equal to 1 or more, which is preferably 10 to 30.

An example of the aforesaid component (A) is the substance shown by the following formula 2:

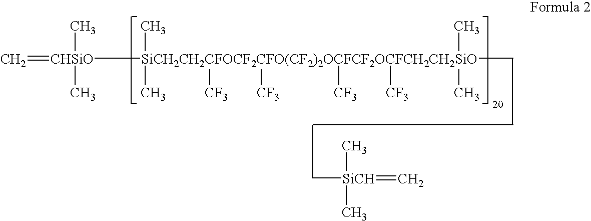

In Component (B), one example of the organopolysiloxane comprising ≡SiH groups is an organohydrogenpolysiloxane having at least two hydrogen atoms bonded to silicon atoms in the molecule.

In the fluorocarbon siloxane rubber composition, when the organocarbon polymer of Component (A) comprises an aliphatic unsaturated group, the aforesaid organohydrogenpolysiloxane may be used as a curing agent. Specifically, in this case, the cured product is formed by an addition reaction between aliphatic unsaturated groups in the fluorocarbon siloxane, and hydrogen atoms bonded to silicon atoms in the organohydrogenpolysiloxane.

Examples of the organohydrogenpolysiloxanes are the various organohydrogenpolysiloxanes used in addition curing silicone rubber compositions.

It is generally preferred that the organohydrogenpolysiloxane is blended in such a proportion that the number of SiH groups therein is at least one, and particularly 1 to 5, relative to one aliphatic unsaturated hydrocarbon group in the fluorocarbon siloxane of Component (A).

It is preferred that in the fluorocarbon containing SiH groups, one unit of Formula 1 or R¹⁰ in Formula 1 is a dialkylhydrogensiloxane, the terminal group is a SiH group such as dialkylhydrogensiloxane or silyl, and it can be represented by the following formula 3.

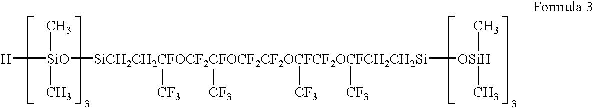

The filler which is Component C may be various fillers used in ordinary silicone rubber compositions. Examples are reinforcing fillers such as for example mist silica, precipitated silica, carbon powder, titanium dioxide, aluminum oxide, quartz powder, talc, sericite and bentonite, or fiber fillers such as asbestos, glass fiber and organic fibers or the like.

Examples of the catalyst which is Component (D) are chloroplatinic acid which is known in the art as an addition reaction catalyst, alcohol-modified chloroplatinic acid, complexes of chloroplatinic acid and olefins, platinum black or palladium supported on a carrier such as alumina, silica or carbon, and Group VIII elements of the Periodic Table or their compounds such as complexes of rhodium and olefins, chlorotris(triphenylphosphine) rhodium (Wilkinson catalyst) and rhodium (III) acetyl acetonate, and it is preferred to dissolve these complexes in an alcohol, ether or a hydrocarbon solvent.

Various blending agents may be added to the fluorocarbon siloxane rubber composition to the extent that they do not interfere with the purpose of the invention which is to improve solvent resistance. For example, dispersing agents such as diphenylsilane diol,els off when separated. low polymer chain end hydroxyl group-blocked dimethylpolysiloxane and hexamethyl disilazane, heat resistance improvers such as ferrous oxide, ferric oxide, cerium oxide and octyl acid iron, and colorants such as pigments or the like, may be added as necessary.

The belt member is obtained by covering the surface of a heat resistant resin or metal belt with the aforesaid fluorocarbon siloxane rubber composition, and heat curing it, but the composition may be diluted to form a coating solution with a solvent such as m-xylene hexafluoride or benzotrifluoride which is then applied by an ordinary coating method such as spin coating, dip coating or knife coating. The heat curing temperature and time can be conveniently selected, but the selection is generally made, according to the belt type and manufacturing method, within the ranges of 100 to 500° C. and 5 seconds to 5 hours.

The thickness of the fluorocarbonsiloxane rubber layer arranged on the surface of the belt member is not specifically limited, can be appropriately set depending on an intended purpose and is preferably from 20 μm to 500 μm, and more preferably from 40 μm to 200 μm.

To effectively yield an image-receiving sheet having high surface smoothness and satisfactory glossiness, the surface roughness [arithmetic average roughness Ra] of the belt member is preferably 20 μm or less, more preferably 5 μm or less, and further preferably 1 μm or less. The surface roughness Ra can be determined according to JIS B 0601, JIS B 0651, and JIS B 0652.

The process used for forming an image on the image-receiving sheet for electrophotography of the present invention is not specifically limited provided that it is an electrophotographic process using a fixing belt. Hence, any of the usual electrophotographic processes may be used. For example, a color image may conveniently be formed on the image-receiving sheet for electrophotography of the present invention. A color image can be formed using an electrophotographic apparatus which permits a full color image to be formed. An ordinary electrophotographic apparatus comprises an image-receiving sheet transport part, latent image-forming part, and developing part disposed in the vicinity of the latent image forming part. Depending on the type, it may also comprise a latent image-forming part in the center of the apparatus, and a toner image intermediate transfer part in the vicinity of the image-receiving sheet transport part.

To improve image quality, adhesive transfer or heat assistance transfer methods may be used instead of electrostatic transfer or bias roller transfer, or in conjunction therewith. The detailed construction is described for example in JP-A Nos. 63-113576 and 05-341666. The intermediate transfer belt in the heat assistance transfer method is particularly preferred when small particle diameter toner is used.

According to the process for image formation of the present invention, peeling of the image-receiving sheet and toner or offset of the image-receiving sheet and toner components can be prevented even if an oilless machine without any fixing oil is used. A stable paper feed can be realized, and a good image with unprecedented gloss and the rich features of a photograph, can be obtained.

The present invention will now be described in further detail with reference to specific examples, but the present invention is not limited thereto.

### EXAMPLE 1

### Manufacture of Raw Paper

A broadleaf kraft pulp (LBKP) was beaten to 300 ml (Canadian Standard Freeness, C.S.F.) by a disk refiner, and adjusted to 0.58 mm of fiber length. Additives were added in the following proportions to this pulp, based on the mass of pulp.

| Type of additive | Amount (%) |
|---|---|
| Cationic starch | 1.2 |
| Alkyl ketene dimer (AKD) | 0.5 |
| Anionic polyacrylamide | 0.3 |
| Epoxy fatty acid amide (EFA) | 0.2 |
| Polyamide Polyamine epichlorohydrine | 0.3 |

Notes
AKD is an alkyl ketene dimer (the alkyl part derives from a fatty acid based on behenic acid), and EFA is an epoxy fatty acid amide (the fatty acid part derives from a fatty acid based on behenic acid).

A raw paper of weighting 150 g/m² was produced from the obtained pulp by a fortlinear paper machine. 1.0 g/m² PVA and 0.8 g/m² CaCl₂ were made to adhere thereto by a size press device in the middle of the drying zone of the fortlinear paper machine.

In the last step of the paper-making process, the density was adjusted to 1.01 g/cm³ using a soft calender. The paper was passed through so that the side (surface) of the raw paper whereon the toner-image-receiving layer is provided, came into contact with the metal roller. The surface temperature of the metal roller was 140° C. The Wang Research smoothness of the obtained raw paper was 265 seconds, and the Stokigt sizing degree was 127 seconds.

Preparation of Support

The above-prepared raw paper was subjected to corona discharge at a power of 17 kW. A single layer of a polyethylene resin having a composition shown in Table 1 was extruded and laminated onto the back side of the raw paper using a cooling roll with a surface matte roughness of 10 μm at a temperature of discharged melted film of 320° C. and at a line speed of 250 m/minute and thereby yielded a backside polyethylene resin layer 22 μm thick.

TABLE 1

| | MFR | Density | Content |
|---|---|---|---|
| Composition | (g/10-min) | (g/cm³) | (mass %) |
| HDPE | 12 | 0.967 | 70 |
| LDPE | 3.5 | 0.923 | 30 |

Next, a single layer of a mixture containing an LDPE master batch shown in Table 2 and having a composition shown in Table 4 was extruded and laminated onto the front side of the raw paper, on which the toner-image-receiving layer would be formed, using a cooling roll with a surface matte roughness of 0.7 μm at a temperature of discharged melted film of 320° C. and at a line speed of 250 m/minute and thereby yielded a front side polyethylene resin layer 29 μm thick.

The melt flow rate (MFR) and mass-average density of the front side polyethylene resin layer of the support according to Example 1 are shown in Table 5.

The front side polyethylene resin layer and the backside polyethylene resin layer were subjected to corona discharge at power of 18 kW and 12 kW, respectively. A gelatin-containing undercoat layer was formed on the front side polyethylene resin layer, an antistatic undercoat layer containing colloidal alumina, colloidal silica, and a poly(vinyl alcohol) (PVA) was formed on the backside polyethylene resin layer and thereby yielded a support according to Example 1.

TABLE 2

| Composition | Content (mass %) |
|---|---|
| LDPE (ρ = 0.921 g/cm³) | 37.98 |
| Anatase-type titanium dioxide | 60 |
| Zinc stearate | 2 |
| Antioxidant | 0.02 |

Production of Image-Receiving Sheet for Electrophotography

To the front side of the support according to Example 1, a coating composition shown in Table 3, comprising an aqueous dispersion of a self-dispersible polyester resin, an aqueous dispersion of a carnauba wax, a poly(vinyl alcohol) (PVA) dispersion of an anatase titanium oxide, a polyethylene oxide having a molecular weight of about 100000, and an anionic surfactant was applied to coated amounts shown in Table 3 using a bar coater and thereby yielded an image-receiving sheet for electrophotography according to Example 1. The coating composition had a viscosity of 70 mPa·s, a surface tension of 30 mN/m, and pH of 7.8.

The image-receiving sheet for electrophotography according to Example 1 had a whiteness of 87 and an opacity of 93.

TABLE 3

| Toner image receiving layer | Coated amount |
|---|---|
| composition | (g/m²) |
| Polyester resin | 11.0 |
| Carnauba wax | 1.2 |
| Anatase-type titanium dioxide | 1.1 |
| PVA-205 | 0.15 |
| Polyethylene oxide | 2.9 |
| Anionic surfactant | 0.3 |

### EXAMPLE 2

An image-receiving sheet for electrophotography according to Example 2 was produced by the procedure of Example 1, except that the polyethylene resin on the front side (the side on which the toner-image-receiving layer would be formed) of the raw paper had a final composition shown in Table 4.

The melt flow rate (MFR) and mass-average density of the front side polyethylene resin layer of the support according to Example 2 are shown in Table 5.

### EXAMPLE 3

An image-receiving sheet for electrophotography according to Example 3 was produced by the procedure of Example 1, except that the polyethylene resin on the front side (the side on which the toner-image-receiving layer would be formed) of the raw paper had a final composition shown in Table 4.

The melt flow rate (MFR) and mass-average density of the polyethylene resin layer of the support according to Example 3 are shown in Table 5.

### COMPARATIVE EXAMPLE 1

An image-receiving sheet for electrophotography according to Comparative Example 1 was produced by the procedure of Example 1, except that the polyethylene resin on the front side (the side on which the toner-image-receiving layer would be formed) of the raw paper had a final composition shown in Table 4.

The melt flow rate (MFR) and mass-average density of the polyethylene resin layer of the support according to Comparative Example 1 are shown in Table 5.

TABLE 4

| | Content (mass %) | | | |
|---|---|---|---|---|
| Composition | Ex. 1 | Ex. 2 | Ex. 3 | Com. Ex. 1 |
| LDPE 1 | 67.7 | — | — | 37.2 |
| (ρ = 0.921 g/cm³) | | | | |
| LDPE 2 | — | 63.2 | — | — |
| (ρ = 0.921 g/cm³) | | | | |
| LDPE 3 | — | — | 39.6 | — |
| (ρ = 0.923 g/cm³) | | | | |
| HDPE 4 | — | 4.5 | 28.1 | 30.5 |
| (ρ = 0.964 g/cm³) | | | | |
| Anatase-type titanium dioxide | 30 | 30 | 30 | 30 |
| Zinc stearate | 2 | 2 | 2 | 2 |
| Ultramarine blue | 0.3 | 0.3 | 0.3 | 0.3 |

TABLE 5

| | Mass-average | MFR |
|---|---|---|
| | density (g/cm³) | (g/10-min) |
| Example 1 | 0.921 | 7.5 |
| Example 2 | 0.924 | 10.5 |
| Example 3 | 0.932 | 9.5 |
| Com. Ex. 1 | 0.94 | 12.5 |

Performance Evaluation

Each of the image-receiving sheets for electrophotography according to Examples 1 to 3 and Comparative Example 1 was cut to a A6 size, on which white, gray, black, yellow, magenta, cyan, blue, green, and red color images were printed using a color electrophotographic printer DocuCentre Color 400 available from Fuji Xerox Co., Ltd., Japan.

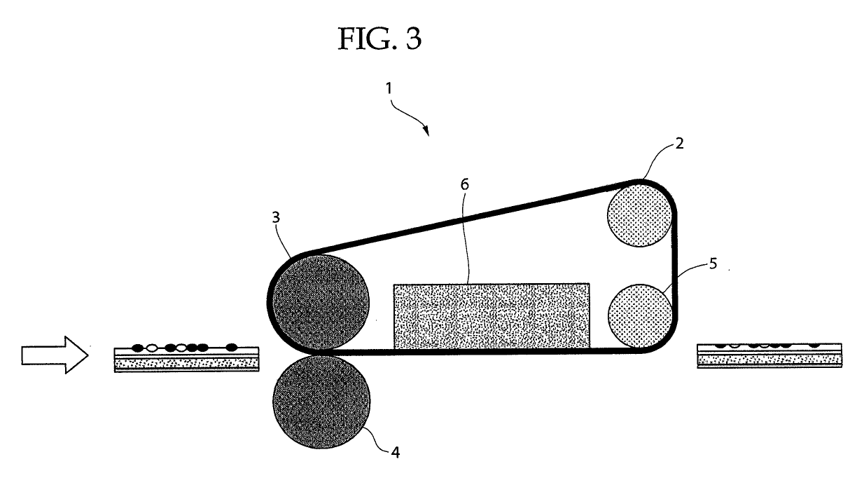

The printed color images were subjected to after-glossing using the belt fixing device 1 shown in FIG. 3, at a transport speed of the belt 2 of 60 mm/sec. and set temperatures of the heat roller 3 and pressure roller 4 as sown in Table 6. FIG. 3 illustrates a cooling device 6.

The 20-degrees glossiness of individual colors was measured according to JIS Z 8741, and the “minimum glossiness” among colors was determined. The results are shown in Table 6.

TABLE 6

| Roller | Minimum glossiness | | | |
|---|---|---|---|---|
| temperature | Example 1 | Example 2 | Example 3 | Com. Ex. 1 |
| 110° C. | 63 | 61 | 59 | 51 |
| 115° C. | 78 | 78 | 77 | 66 |
| 120° C. | 81 | 80 | 82 | 74 |
| 125° C. | 83 | 83 | 81 | 80 |
| 130° C. | 77 | 79 | 77 | 75 |

Table 6 shows that the image-receiving sheets according to Examples 1 to 3 each have a minimum glossiness higher than that of the image-receiving sheet according to Comparative Example 1. They exhibit a glossiness of 75 or more in the range of set temperatures of rollers from 115° C. to 130° C., whereas the image-receiving sheet according to Comparative Example 1 has a glossiness of 75 or more in the range of set temperatures of rollers from 125° C. to 130° C. Thus, image-receiving sheets according to Examples 1 to 3 have larger process margin and are more advantageous than the image-receiving sheet according to Comparative Example 1.

According to the present invention, the resin layer of the support arranged between the toner-image-receiving layer and the base comprises a polyethylene resin having a mass-average density of 0.935 g/cm³ or less and/or a polyethylene resin having a melt flow rate MFR of 11 g/10-min or less. Thus, the image-receiving sheets for electrography of the present invention allow the toner to fix satisfactorily and can form high-quality images with satisfactory glossiness.

### EXAMPLE 4

The raw paper obtained in EXAMPLE 1 was treated with a corona discharge of 17 kW output. Then, on the back side of the raw paper using a cooling roller having a surface mat roughness of 10 μm, a polyethylene resin having a composition shown in Table 7 was applied with single layer extrusion lamination at melt extruded film temperature of 320° C. and at line speed of 250 m/min. Thus, a back side polyethylene resin layer having a thickness of 22 μm was formed.

TABLE 7

| | MFR | Density | Added amount |
|---|---|---|---|
| Composition | (g/10 min.) | (g/cm³) | (% by mass) |
| HDPE | 12 | 0.967 | 50 |
| LDPE | 3.5 | 0.923 | 50 |

Next, the same LDPE of Table 7, pellets of a masterbatch of TiO₂ having a composition shown in Table 8, and pellets of a masterbatch containing 5% by mass of ultramarine were mixed so that the mixture has a final composition as shown in Table 9. Then, on the front side of the raw paper, on which an image is formed, using a cooling roller having a surface mat roughness of 0.7 μm, the mixture is extruded and laminated at a line speed of 250 m/min. so as to form a toner-image-receiving layer. Then, the front side of the toner-image-receiving layer was treated with a corona discharge at 18 kW, and the back side was treated with a corona discharge at 12 kW. Thus the image-receiving sheet for electrophotography of Example 4 was formed.

TABLE 8

| Composition | Amount (% by mass) |
|---|---|
| LDPE (ρ = 0.921 g/cm³) | 37.98 |
| TiO₂ | 60 |
| Zinc stearate | 2 |
| Antioxidant | 0.02 |

TABLE 9

| | Amount | Thickness | Resin |
|---|---|---|---|
| Composition | (% by mass) | (μm) | temperature (° C.) |
| LDPE | 67.7 | 28 | 326 |
| (ρ = 0.921 g/cm³) | | | |
| TiO₂ pigment | 30 | — | — |
| Zinc stearate | 2 | — | — |
| Ultramarine | 0.3 | — | — |

Process for Color Electrophotography

On the image-receiving sheet for electrophotography of Example 4, images were developed and transferred using a color electrophotographic printer DCC-400 by Fuji Xerox Co., Ltd. The sheets were taken out prior to fixing, and the images were fixed using a cold release fixing device shown in FIG. 2 with nip pressure between rollers at 5 kgf/cm² (cold releasing treatment). The prints contained images of white background to black solid parts using the toners as described below.

Heating conditions in this cold releasing treatment were shown in Table 10, and the temperature at which sheets were released was 80° C. or lower. The fixing belt which was used is described below.

Toner

Styrene-acrylic resin toners having an average particle diameter of 5.5 μm (DCC400S developing agent) were used as provided for the color electrophotographic printer DCC-400 by Fuji Xerox Co., Ltd.

| | |
|---|---|
| Toner 1 | aggregation melted toner - cyan |
| Toner 2 | aggregation melted toner - black |
| Toner 3 | aggregation melted toner - yellow |
| Toner 4 | aggregation melted toner - magenta |

Belt

The fixing belt was prepared as follows. On a polyimide base layer as a base for the fixing belt, a silicone rubber primer DY39-115 by Dow Corning Toray Silicone Co., Ltd. was applied, and after being dried with air for 30 minutes, an application solution prepared from 100 parts by mass of DY-35-796AB, which is a silicone rubber precursor, and 30 parts by mass of n-hexane was applied by immersion to form a coating. Then, a primary vulcanization was conducted at 120° C. for 10 minutes. Thus a silicone rubber layer having a thickness of 40 μm was formed.

On the silicone rubber layer, an application solution prepared from 100 parts by mass of SIFEL 610, which is a precursor of fluorocarbon siloxane rubber by Shin-Etsu Chemical Co., Ltd., and 20 parts by mass of fluorine solvent (a mixture solvent of m-xylenehexafluoride, perfluoroalkane, and perfluoro(2-butyltetrahydrofuran)) was applied by immersion to form a coating. Then, a primary vulcanization was conducted at 120° C. for 10 minutes, and a secondary vulcanization was conducted at 180° C. for 4 hours. Thus a fluorocarbon siloxane rubber layer having a thickness of 20 μm was formed, and the fixing belt was made.

(i) Heating Conditions

The highest temperatures of the toner-image-receiving layers in the nip were measured and the results were considered as actual temperatures as shown in Table 10. In Table 10, the area surrounded by double lines (the area painted in gray) represents the preferable range of the present invention.

TABLE 10

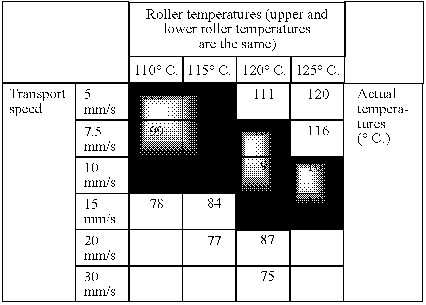

For the electrophotographic prints obtained in Example 4, evaluations of glossiness, relief, offset, and blister were conducted as follows.

(ii) Glossiness

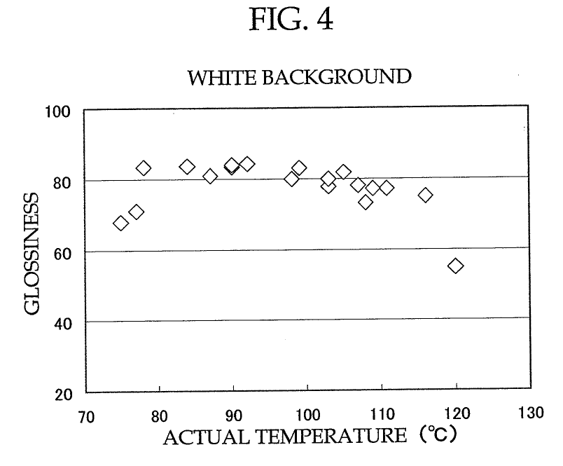

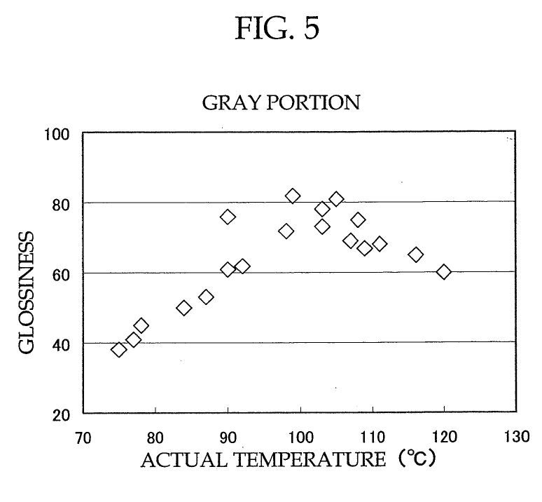

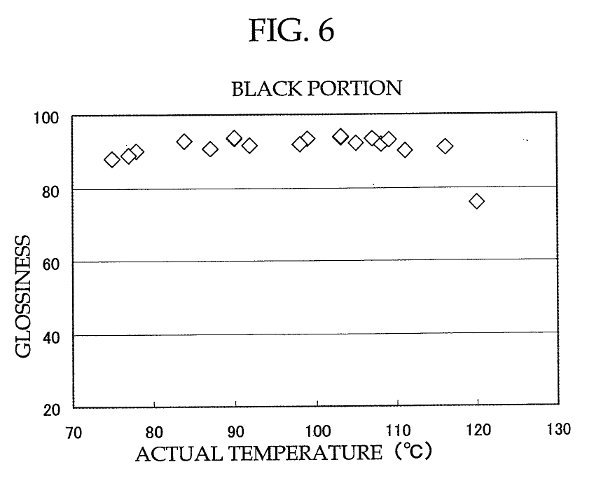

Glossinesses of a white background, a gray portion having a density of about 0.8, and a black portion were measured by 20-degrees glossiness measurement as defined by JIS Z8741. Results are shown in Tables 11 to 13 and FIGS. 4 to 6. In the Tables, the areas surrounded by dotted lines represent suitable ranges. White glossiness, gray glossiness, and black glossiness are preferably 65 or more.

TABLE 11
Glossiness of white background

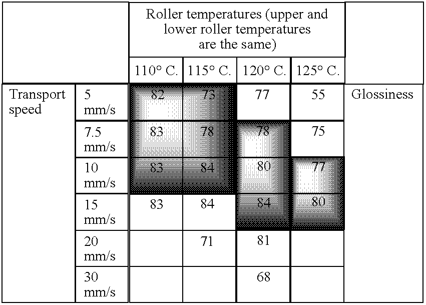

TABLE 12
Glossiness of gray portion

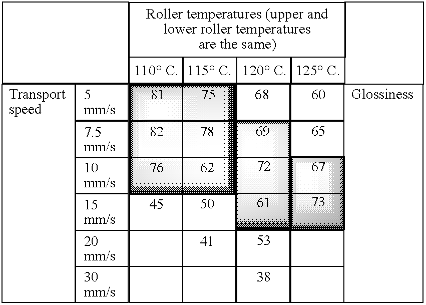

TABLE 13
Glossiness of black portion

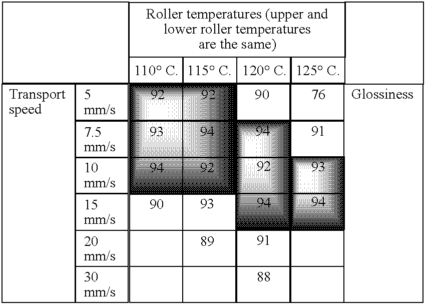

It can be seen from the results of Tables 11 to 13 and FIGS. 4 to 6 that glossiness declines at high temperatures, presumably affected by hot offset. Typically, toner resins are designed to become plastic at temperatures in a fixing temperature range and therefore a black portion tends to have high glossiness because the toner is covering the entire area. A gray portion, in which the toner is applied only partially, has more asperity and therefore has less glossiness compared with white background and black portions. It is also understood from the results that at substantially the same actual temperatures, high glossiness can be obtained when the roller temperature is low and the transport speed is low. Therefore, it is confirmed that long nip time gives good results.

(iii) Relief

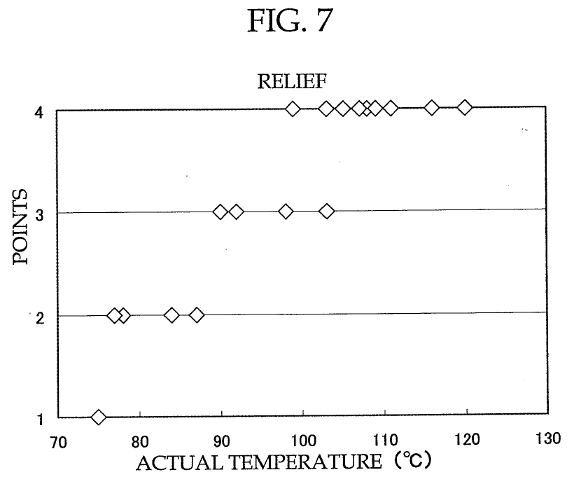

Relief was evaluated as the difference of the levels of a black portion and white background at their border (thickness of the black portion) being observed with naked eyes using the standards described below. Results are shown in Table 14 and FIG. 7. In Table 14, the area surrounded by dotted lines represents a suitable range.

Standards

G (4 points): Good. Hardly detectable with naked eyes.

G-F (3 points): Good to Fair. Detachable, but not bothering.

F (2 points): Fair. Bothering.

B (1 points): Bad. Unacceptable.

TABLE 14
Relief

| | | Roller temperatures (upper and lower | | | | |
|---|---|---|---|---|---|---|
| | | roller temperatures are the same) | | | | |
| | | 110° C. | 115° C. | 120° C. | 125° C. | |
| Transport | 5 mm/s | G | G | G | G | Relief |
| speed | 7.5 mm/s | G | G | G | G | |
| | 10 mm/s | G-F | G-F | G-F | G | |
| | 15 mm/s | F | F | G-F | G-F | |
| | 20 mm/s | | F | F | | |
| | 30 mm/s | | | B | | |

From the results of Table 14 and FIG. 7, it is found that relief has the same trend as glossiness in that at substantially the same temperatures, results were better when the roller temperature is low and the transport speed is low.

(iv) Offset

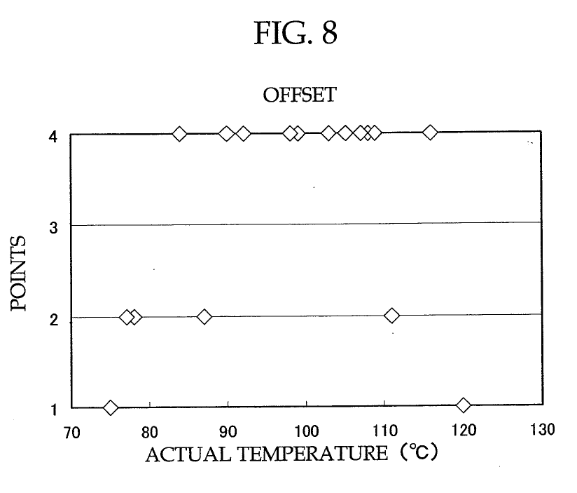

Offset was evaluated as whether or not an image is adhered to the fixing belt or the like being observed with naked eyes using the standards described below. Results are shown in Table 15 and FIG. 8. In Table 15, the area surrounded by dotted lines represents a suitable range.

Standards

TABLE 15
Offset

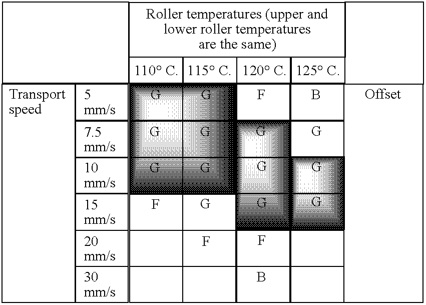

G (4 points): Good. Unable to identify adhesion.
G-F (3 points): Good to Fair. Adhesion identified, but not bothering.
F (2 points): Fair. Adhesion observed.
B (1 point): Bad. A lot of adhesion.

It is understood from the results of Table 15 and FIG. 8 that hot offset occurs at high temperatures and cold offset occurs at low temperatures.

(v) Blister

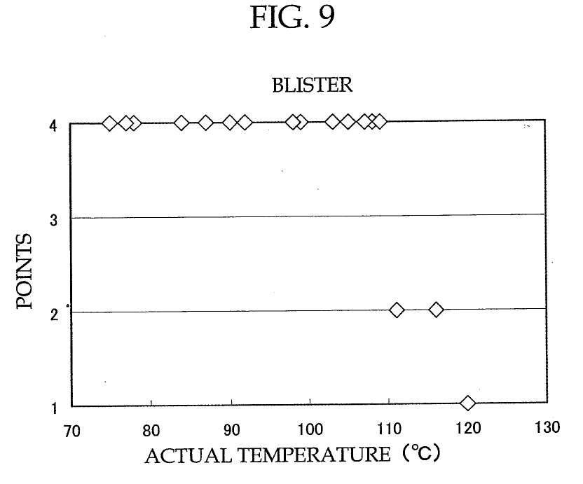

Blister was evaluated as the occurrence of bubbles on an image being observed with naked eyes using the standards described below. Results are shown in Table 16 and FIG. 9. In Table 16, the area surrounded by dotted lines represents a suitable range.

Standards

TABLE 16
Blister

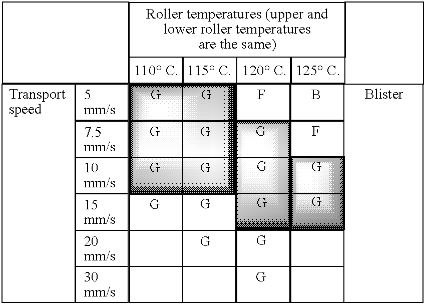

G (4 points): Good. Unable to identify bubbles.
G-F (3 points): Good to Fair. Bubbles identified, but not bothering.
F (2 points): Fair. Bubbles observed.
B (1 point): Bad. A lot of Bubbles.

In Tables 10 to 16, the areas surrounded by double lines (the area painted in gray) represent the range of the present invention. The areas surrounded by dotted lines represent preferable ranges for each of the properties, and the area surrounded by the double lines is the product set of all the dotted lined areas. In other words, actual temperatures within the double-lined area satisfy all the properties.

### COMPARATIVE EXAMPLE 2

Using the same raw paper as Example 4, image-receiving sheets for electrophotography of Comparative Example 2 were prepared as described below.

Preparation of Application Solution for Toner-Image-Receiving Layer

Titanium Dioxide Dispersion

First, 40.0 g of titanium dioxide (Typec (registered trademark) A-220, by Ishihara Sangyo Kaisha, Ltd.), 2.0 g of polyvinyl alcohol (PVA102, by Kuraray Co., Ltd.) and 58.0 g of ion-exchanged water were mixed. Then, using an NBK-2 by Nippon Seiki Co., Ltd. to disperse the mixture, a titanium dioxide dispersion (40% by mass of titanium dioxide pigment) was prepared.

Application Solution for Toner-Image-Receiving Layer

Next, 15.5 g of the titanium dioxide dispersion, 15.0 g of a carnauba wax dispersion (Cellosol 524, by Chukyo Yushi Co., Ltd.), 100.0 g of polyester resin dispersion (solids 30% by mass, KZA-7049, by Unitika Ltd.), 4.0 g of viscosity enhancer (Alcox E30, by Meisei Chemical Works, Ltd.), 0.5 g of anionic surfactant (AOT), and 20 ml of ion-exchanged water were mixed and thus an application solution for toner-image-receiving layer was prepared.

The viscosity of the application solution for toner-image-receiving layer, in which titanium dioxide was included in an amount of 21% by mass to the polyester resin, was 50 mPa·s and its surface tension was 33 mN/m.

Preparation of Application Solution for Intermediate Layer

Then, 100.0 g of styrene butadiene rubber resin dispersion (solids 50% by mass, Nipol LX-426, by Zeon Corporation), 2.0 g of viscosity enhancer (Alcox R-400, by Meisei Chemical Works, Ltd.), 0.2 g of anionic surfactant (AOT), and 60 ml of ion-exchanged water were mixed and thus an application solution for intermediate layer was prepared.

The viscosity of the application solution for intermediate layer was 85 mPa·s and its surface tension was 36 mN/m.

Preparation of Application Solution for Back Layer

Next, 150.0 g of acrylic resin aqueous dispersion (solids 30% by mass, DICfine K-96, Dainippon Ink and Chemicals, Inc.), 8.0 g of mat agent (Tecpomar MBX-8, Sekisui Plastics Co., Ltd.), 5.0 g of release agent (Hydrine D337, Chukyo Yushi Co., Ltd.), 0.5 g of viscosity enhancer (Alcox E30, by Meisei Chemical Works, Ltd.), 0.5 g of anionic surfactant (AOT), and 40 ml of ion-exchanged water were mixed and thus an application solution for back layer was prepared.

The viscosity of the application solution for back layer was 60 mPa·s and its surface tension was 34 mN/m.

Coating of Toner-Image-Receiving Layer, Intermediate Layer, and Back Layer

The application solution for back layer was applied to the back side of the same raw paper as Example 4 using a bar coater. Then, to the front side of the same raw paper as Example 4, the application solution for intermediate layer and application solution for toner-image-receiving layer were applied in this sequence using the bar coater as was done with the back layer.

The application solution for toner-image-receiving layer, application solution for intermediate layer, and application solution for back layer were applied so that 9.5 g/m² in dry mass were applied for back layer, 4.0 g/m² for intermediate layer, and 8.0 g/m² for toner-image-receiving layer.

After application, the back layer and toner-image-receiving layer were dried by hot blast on-line. The air flow for drying and temperature were adjusted so that the back surface and toner-image-receiving layer were dried within 2 minutes after application. The drying point was set so that the coated surface temperature was identical to the wet-bulb temperature of the drying air.

After drying, calendering was performed using a gloss calender with a metal roller adjusted to 30° C., and at a pressure of 147 N/cm² (15 kgf/cm²).

Using the image-receiving sheet for electrophotography of Comparative Example 2, images were developed and transferred in the same manner as Example 4 using a color electrophotographic printer DCC-400 by Fuji Xerox Co., Ltd. and subsequently fixed without oil (oil-less fixing). Printed images included white background to black solid portion. Fixing was conducted at nip pressure between rollers of 5 kgf/cm², transport speed of 50 mm/s, and roller temperature of 145° C.

Evaluation of Blocking

Evaluation of blocking under Condition 1 and Condition 2 as described below were conducted using the image-receiving sheet for electrophotography of Example 4 to which fixing was conducted under heating conditions of roller temperature at 110° C. and transport speed at 7.5 mm/s, and the image-receiving sheet for electrophotography of Comparative Example 2. Results are shown in Table 17.

Condition 1

An environment of 80% relative humidity (RH) and 45° C. was kept for 16 hours. Then, in the environment, a sheet was laid on another sheet so that the surfaces of images of white and black portions were in contact with each other, and a load of 50 g/cm² was applied, and the sheets were kept in the same environment for 1 week. Next, in an environment of 25° C. and 50% RH, the load was lifted, and evaluations were made with naked eyes on the extent of adhesion between the surfaces and on whether marks of adhesion were seen on the surfaces according to the standards as described below.

Condition 2

Under a condition of 50° C. (humidity not defined), a sheet was laid on another sheet so that the surfaces of images of white and black portions were in contact with each other, and a load of 50 g/cm² was applied, and the sheets were kept in the same environment for 1 week. Next, in an environment of 25° C. and 50% RH, the load was lifted, and evaluations were made with naked eyes on the extent of adhesion between the surfaces and on whether marks of adhesion were seen on the surfaces according to the standards as described below.

Standards

VG: Very good. Sheets are not adhered at all.

G: Good. Adhered, but easily separated and no marks observed.

F: Fair. Adhered, but easily separated and some marks.

B: Bad. Adhered, and marks observed when separated.

VB: Very bad. Adhered, and a portion of paper peels off when separated.

TABLE 17

| | Condition 1 | Condition 2 |
|---|---|---|
| Example 4 | VG | G |
| Comp. Ex. 2 | F | B |

According to the present invention, it is possible to obtain an image-receiving sheet for electrophotography that suppresses blocking occurrence, excels in glossiness and smoothness, is high image quality although there is no need for a special layer and its structure is simple, by forming a toner-image-receiving layer containing a polyolefin resin as main component on at least one side of a support.

1-25. (canceled)

26. A process for forming an image-receiving sheet for electrophotography, comprising the steps of:
forming a support by coating a resin on at least one side of a base; and
forming at least one toner-image-receiving layer over the resin layer by applying a self-dispersing water-dispersible polyester resin emulsion which satisfies the following properties (1) to (4) on the resin layer:
(1) number average molecular weight (Mn)=5000 to 10000;
(2) molecular weight distribution (weight average molecular weight/number average molecular weight)<4;
(3) glass transition temperature (Tg) 40° C. to 100° C.; and
(4) volume average particle diameter=20 nm to 200 nm,
wherein the image-receiving sheet for electrophotography comprises:
the base;
the resin layer;
the support which comprises the resin layer disposed on at least one side of the base; and
the toner-image-receiving layer over the support, and
wherein the resin layer arranged between the toner-image-receiving layer and the base contains at least one polyethylene resin having a mass-average density of 0.935 g/cm³ or less and
at least one polyethylene resin having a melt flow rate (MFR) of 11 g/10 min. or less, provided that if the resin layer contains a mixture of two or more polyethylene resins, the mixture of two or more polyethylene resins has an MFR of 11 g/10 min. or less.

27. The process for forming an electrophotographic image-receiving sheet according to claim 26, wherein the at least one polyethylene resin having a mass-average density of 0.935 g/cm³ or less has a mass-average density of 0.925 g/cm³ or less.

28. The process for forming an electrophotographic image-receiving sheet according to claim 26, wherein the polyethylene resin having a melt flow rate (MFR) of 11 g/10 min. or less has a melt flow rate of 2 to 10 g/10 min.

29. The process for forming an electrophotographic image-receiving sheet according to claim 26, wherein the resin layer arranged between the toner-image-receiving layer and the base contains at least two polyethylene resins having different mass-average densities.

30. The process for forming an electrophotographic image-receiving sheet according to claim 26, wherein the resin layer of the support is formed by melt extrusion coating.

31. The process for forming an electrophotographic image-receiving sheet according to claim 26, wherein a content of polyethylene resin in the resin layer arranged between the toner-image-receiving layer and the base is 60% by mass or more.

32. An image-receiving sheet for electrophotography, comprising:
a support; and
at least one toner-image-receiving layer over the support, wherein the toner-image-receiving layer contains a polyolefin resin.

33. An image-receiving sheet for electrophotography according to claim 32, wherein an amount of the polyolefin resin in the toner-image-receiving layer is 60% by mass or more.

34. An image-receiving sheet for electrophotography according to claim 32, wherein the toner-image-receiving layer is formed by melt extrusion coating.

35. An image-receiving sheet for electrophotography according to claim 32, wherein the support is selected from raw paper, synthetic paper, synthetic resin sheet, coated paper, and laminated paper.

36. An image-receiving sheet for electrophotography according to claim 26, wherein a toner to be received by the toner-image-receiving layer comprises a binder resin and a colorant, wherein a volume average particle diameter of the toner is from 0.5 μm to 10 μm and volume average particle size distribution index (GSDv) is 1.3 or less.

37. An image-receiving sheet for electrophotography according to claim 36, wherein a ratio (GSDv/GSDn) of the volume average particle size distribution index (GSDv) of the toner to a number average particle size distribution index (GSDn) is 0.95 or more.

38. An image-receiving sheet for electrophotography according to claim 36, wherein the volume average particle diameter of the toner is from 0.5 μm to 10 μm and an average value of shape indices of the toner is from 1.00 to 1.50, wherein the shape index is defined by the following formula:
Shape index=(π×L²)/(4×S)
wherein “L” represents a maximum length of a toner particle and “S” represents a projected area of the toner particle.

39. An image-receiving sheet for electrophotography according to claim 36, wherein the toner is manufactured by a process comprising:
(i) forming aggregated particles in a dispersion in which resin particles are dispersed, so as to prepare aggregated particle dispersion;
(ii) adding and mixing a fine particle dispersion in which fine particles are dispersed, into the aggregated particle dispersion, so as to form adhesion particles in which the fine particles adhere to the aggregated particles; and
(iii) heating and fusing the adhesion particles, so as to form toner particles.

40. A process for image formation using an image-receiving sheet for electrophotography,
the image-receiving sheet comprising:
a base;
a resin layer;
a support which comprises the resin layer disposed on at least one side of the base; and
at least one toner-image-receiving layer over the support,
wherein the resin layer arranged between the toner-image-receiving layer and the base contains at least one polyethylene resin having a mass-average density of 0.935 g/cm³ or less,
the process comprising the steps of:
forming a toner image on an image-forming surface of the image-receiving sheet for electrophotography;
heating and pressurizing the toner image-bearing surface of the image-receiving sheet for electrophotography using a fixing belt and a fixing roller;
cooling the heated and pressurized toner image-bearing surface; and
removing the cooled toner image-bearing surface from the fixing belt.

41. A process for image formation according to claim 40, further comprising:
fixing the toner image by a heating roller,
wherein fixing is carried out after the step of forming and before the step of heating and pressurizing.

42. A process for image formation according to claim 40, wherein the fixing belt comprises:
a fluorocarbon siloxane rubber layer disposed over a surface of the fixing belt; and
an optional silicone rubber layer, wherein the fluorocarbon siloxane rubber layer is disposed on the silicone rubber layer.

43. A process for image formation according to claim 42, wherein the fluorocarbonsiloxane rubber layer has at least one of perfluoroalkyl ether groups and perfluoroalkyl groups in its principal chain.

44. A process for image formation using an image-receiving sheet for electrophotography,
the image-receiving sheet for electrophotography comprising:
a support; and
at least one toner-image-receiving layer over the support, wherein the toner-image-receiving layer contains a polyolefin resin, wherein an amount of the polyolefin resin in the toner-image-receiving layer is 60% by mass or more,
the process comprising:
forming a toner image on an image-forming surface of the image-receiving sheet for electrophotography;
heating and pressurizing the toner image-bearing surface of the image-receiving sheet for electrophotography using a fixing belt and a fixing roller;
cooling the heated and pressurized toner image-bearing surface; and
removing the cooled toner image-bearing surface from the fixing belt.

45. A process for image formation according to claim 44, wherein the image-receiving sheet for electrophtography is heated and pressurized at a temperature of from 80° C. to 110° C. by a fixing belt and a fixing roller and released from the fixing belt at a temperature of 80° C. or less.

46. A process for image formation according to claim 44, wherein the fixing belt comprises:
a fluorocarbon siloxane rubber layer disposed over a surface of the fixing belt; and
an optional silicone rubber layer, wherein the fluorocarbon siloxane rubber layer is disposed on the silicone rubber layer.

47. A process for image formation according to claim 46, wherein the fluorocarbonsiloxane rubber layer has at least one of perfluoroalkyl ether groups and perfluoroalkyl groups in its principal chain.
